(19) United States
(12) Patent Application Publication
(10) Pub. No.: US 2008/0109178 A1
(43) Pub. Date: May 8, 2008

(54) Method and system for predicting and correcting signal fluctuations of an interferometric measuring apparatus

(75) Inventors: Michael R. Sogard, Menlo Park, CA (US); Bausan Yuan, San Jose, CA (US); James Minor, Newark, DE (US); Yu Tang, Sunnyvale, CA (US)

Correspondence Address: Roeder & Broder LLP, 5560 Chelsea Avenue, La Jolla, CA, 92037, US

(73) Assignee: Nikon Corporation, Tokyo (JP)

(21) Appl. No.: 11/982,656

(22) Filed: Nov. 2, 2007

Related U.S. Application Data
(60) Provisional application No. 60/856,630, filed on Nov. 3, 2006.

(51) Int. Cl. G06F 19/00

(52) U.S. Cl. 702/66

(57) ABSTRACT

A method and system for predicting a signal fluctuation due to a flow of gaseous fluid approximately transverse to an optical path between a stage and an interferometric measuring apparatus for determining a position of the stage in a direction of a stage movement. The method includes acquiring three interferometric signals of three parallel optical beams, lying within the flow of the gaseous fluid, reflected from predetermined portions of the stage, extracting a mutual signal fluctuation caused by fluctuations of the gaseous fluid properties from the three interferometric signals, and predicting a future fluctuation of the interferometric signals using a linear adaptive filter acting on the extracted mutual signal fluctuation. Prior to the processing with the adaptive filter, a low-pass filter removes high frequency stage motions, and an adaptive moving average algorithm removes low frequency stage motions. When applied to a two-moving axis configuration, it is possible to use only two interferometers in each direction because of the redundancy of measuring stage yaw.

### RELATED APPLICATION

This application claims priority on U.S. Provisional Application Ser. No. 60/856,630, filed on Nov. 3, 2006, and entitled “METHOD AND SYSTEM FOR PREDICTING AND CORRECTING SIGNAL FLUCTUATIONS OF AN INTERFEROMETRIC MEASURING APPARATUS”. The contents of U.S. Provisional Application Ser. No. 60/856,630 are incorporated herein by reference.

### FIELD OF THE INVENTION

The invention relates to a method and system for predicting and correcting a signal fluctuation of an interferometric measuring apparatus, and in particular, to a method and system for predicting a signal fluctuation due to a gaseous fluid in an optical path of the interferometric measuring apparatus for measuring positions of a moving stage.

### BACKGROUND OF THE INVENTION

Precision stages in lithography and metrology systems are used to position wafers or other specimens to an accuracy on the order of nanometers. The positioning is typically performed using information from laser interferometers which locate the stage to within a small fraction of the wavelength of the laser light. In practice the positional accuracy may be limited by fluctuations in the optical path length of the interferometer, often caused by variations in the index of refraction of the air or gaseous fluid the interferometer beam passes through. These variations can come from temperature variations in the air in the neighborhood of the interferometer which are mixed into the beam path by turbulent processes. They may also arise from compositional changes in the fluid, although this is less common.

Attempts have been made to minimize these temperature fluctuations by controlling the temperature of the near-beam environment and providing a flow of temperature controlled air across or along the beam path. Such methods are difficult, expensive, and not entirely successful. An alternative method, if possible, would be somehow to detect the temperature fluctuations, calculate an equivalent optical path length correction, and apply it to the interferometer signal. However, the detection and signal processing would consume some amount of time, leading to a phase delay between the correction signal and the interferometer signal. Since the stages in the present application are typically controlled by high performance servo systems which use the interferometer signals as input, even a small amount of delay in the correction signal could cause not only errors directly in the correction, but also instability in the servo corrected stage motion.

### SUMMARY OF THE INVENTION

The invention provides a method of predicting a signal fluctuation due to fluctuations in the optical properties of a gaseous fluid in an optical path of an interferometric measuring apparatus which includes obtaining an interferometric signal generated by the interferometric measuring apparatus, and predicting a future fluctuation of the signal using a linear adaptive filter.

The invention also provides a method of predicting a signal fluctuation due to fluctuations in the optical properties of a gaseous fluid in an optical path of a first interferometric measuring apparatus where an air conditioning system provides a flow of gaseous fluid at approximately right angles to the interferometric optical path, and a second interferometric measuring apparatus of similar path length, aligned approximately parallel to the first apparatus, is positioned upstream of the first apparatus, so that the gaseous fluid from the air conditioning system encounters the second apparatus and then the first apparatus. The method includes obtaining an interferometric signal generated by the second interferometric measuring apparatus, and predicting a future fluctuation of the signal of the first interferometric measuring apparatus using a linear adaptive filter.

The invention also provides a method of predicting a signal fluctuation due to fluctuations in the optical properties of a gaseous fluid in an optical path of an interferometric measuring apparatus where an air conditioning system provides a flow of gaseous fluid at approximately right angles to the interferometric beampath, and a distributed gas temperature sensor, of length similar to that of the interferometric optical path and aligned approximately parallel to the first apparatus, is positioned upstream of the first apparatus, so that the gaseous fluid from the air conditioning system encounters the gas temperature sensor and then the first apparatus. The method includes obtaining a temperature signal generated by the gas temperature sensor and predicting a future fluctuation of the signal of the first interferometric measuring apparatus using a linear adaptive filter.

The invention also provides a method of predicting a signal fluctuation due to fluctuations in the optical properties of a gaseous fluid in an optical path between a stage and an interferometric measuring apparatus for determining a position of the stage in a direction of stage movement, where an air conditioning system provides a flow of gaseous fluid at approximately right angles to the interferometric optical path. The method includes acquiring three interferometric signals of three parallel optical beams, all immersed in the approximately transverse flow of gaseous fluid, reflected from predetermined portions of the stage, extracting a mutual signal fluctuation caused by fluctuations in the gaseous fluid from the three interferometric signals, and predicting a future fluctuation of the interferometric signals using a linear adaptive filter acting on the extracted mutual signal fluctuation.

The invention further provides a method of predicting a signal fluctuation due to fluctuations in the optical properties of a gaseous fluid in an optical path between a stage under servo control and an interferometric measuring apparatus for determining a position of the stage in a direction of stage movement, where an air conditioning system provides a flow of gaseous fluid at approximately right angles to the interferometric optical path. The method includes acquiring three interferometric signals of three parallel optical beams, all immersed in the approximately transverse flow of gaseous fluid, reflected from predetermined portions of the stage, determining a following error by subtracting a position defined by the acquired interferometric signal from a position defined by a servo signal as a predetermined position, determining a residual stage motion and a residual stage yaw using adaptive moving averages of acceleration, velocity and position of the stage, obtaining a measurement of a signal fluctuation in the following error caused by a gaseous fluid fluctuation by subtracting the determined residual stage motion and yaw from the following error, and predicting a future following error from the obtained signal fluctuation using a linear adaptive filter.

The invention still further provides a method of predicting a signal fluctuation due to a gaseous fluid in an optical path between a stage and an interferometric measuring apparatus for determining a position of the stage moving in two directions, where an air conditioning system provides local flows of gaseous fluid at approximately right angles to the interferometric optical paths. The method includes acquiring two interferometric signals of two parallel optical beams, each immersed in the approximately transverse local flow of gaseous fluid, reflected from predetermined portions of the stage for each of the two directions of stage movement, extracting a measurement of a mutual signal fluctuation caused by gaseous fluid fluctuations from the four interferometric signals for each of the two directions, and predicting a future fluctuation of the interferometric signal using a linear adaptive filter acting on the extracted mutual signal fluctuation.

The invention provides a stage position control system including three interferometers for measuring a position of a stage in a direction of stage movement. The interferometric signals of the three interferometers are combined to provide a mutual signal fluctuation. The system also includes a servo unit to provide a servo signal to position the stage according to a predetermined sequence, a device predicting a signal fluctuation due to an approximately transverse flow of gaseous fluid in an optical path of the interferometer including a linear adaptive filter acting on the extracted gaseous fluid fluctuation, and a control unit which removes the predicted signal fluctuation of the interferometric signal from a current interferometric signal and uses the current interferometric signal without the predicted signal fluctuation in addition to the servo signal to position the stage accurately.

The invention also provides a lithography system including a reticle stage and a wafer stage in which the motions of the stages are coordinated such that a source of radiation projected through part of a reticle and refocused to an image of the illuminated part of the reticle on a wafer coated with a resist sensitive to the radiation. The system includes three interferometers for measuring a position of the wafer stage in a direction of a stage movement, and an air conditioning system which provides a flow of gaseous fluid at approximately right angles to the interferometric optical paths. The interferometric signals of the three interferometers are combined to provide a mutual signal fluctuation as described below. The system also includes (i) a servo unit to provide a servo signal to position the wafer stage according to a predetermined sequence, (ii) a device for predicting a signal fluctuation due to a gaseous fluid in an optical path of the interferometer, including a linear adaptive filter acting on the signal fluctuation, and (iii) a control unit which removes the predicted signal fluctuation of the interferometric signal from a current interferometric signal. The system uses this current interferometric signal without said predetermined signal fluctuation in addition to the servo signal to position the reticle stage.

### BRIEF DESCRIPTION OF THE DRAWINGS

FIG. 1a shows the performance of a linear adaptive filter predicting the fluctuations of a fixed beam path interferometer.

FIG. 1b shows the power spectral density plotted against frequency for an interferometer signal as well as for the residual error of predictions of the interferometer's future fluctuations.

FIG. 1c shows schematically a physical picture which explains the observed performance of the linear adaptive filter prediction of the interferometer signal fluctuations.

FIG. 2 is a block diagram representing a first embodiment of the invention.

FIG. 3 shows an alignment of the interferometers used in a second embodiment of the invention.

FIG. 4 is a block diagram representing the second embodiment of the invention.

FIG. 5 shows a physical picture affecting time derivatives of the interferometric signal under the influence of air fluctuation.

FIG. 6 shows the performance of the adaptive moving average algorithm for stage yaw when the stage is locked down.

FIG. 7 shows the performance of the adaptive moving average algorithm for stage yaw when the stage is moving.

FIG. 8 shows the stage motion correlated with air fluctuations.

FIG. 9 shows an experimental set-up for obtaining the coefficients of the adaptive moving average algorithm.

FIG. 10 is a block diagram representing a third embodiment of the invention.

FIGS. 11A and 11B show the performance of a prediction method according to the third embodiment of the invention.

FIG. 12 schematically shows a stage position control system based on the invention.

FIG. 13A schematically shows a position control system for a photolithographic instrument having a wafer stage and a reticle stage according to a fourth embodiment of the invention.

FIG. 13B schematically shows a position control system for a photolithographic instrument having a wafer stage and a reticle stage according to a fifth embodiment of the invention.

FIG. 14 shows an alignment of the interferometers used in a sixth embodiment of the invention.

### DETAILED DESCRIPTION OF THE INVENTION

1. Adaptive Filter Prediction of Fluctuations

A first embodiment will be described below on a use of an adaptive filter for predicting signal fluctuations due to air fluctuation. Turbulence associated with air flow is not a stationary process. Therefore whatever model is used to make the predictions must have the ability to change with time, as the turbulence conditions change. A general type of model for this application would be a neural network. However, in accordance with this invention, a linear adaptive filter, which may be regarded as a linearized neural network without a hidden layer, provides adequate performance. With this linear adaptive filter, the interferometer signals are periodically sampled, and all of the signal processing and prediction are digital.

To predict the effect of fluctuations in the future (or the current value based upon past measurements), a linear adaptive filter, more particularly a QR decomposition-recursive least squares (QRD-RLS) filter, is used. Other filters could be used. The QRD-RLS filter was selected because it is relatively robust and requires fewer computations than other filters.

Such filters are theoretically well understood, and their properties are described in textbooks, such as S. Haykin, Adaptive Filter Theory, N.J.: Prentice-Hall, 2nd ed., 1991, incorporated in its entirety herein by reference for all purposes. Briefly, such a filter can analyze a time series of data, detect trends, and make predictions based on the trends. The filter constantly adapts to any changes in the data trends.

The QRD-RLS algorithm operates recursively upon an observed time series
u(1),u(2), . . . , u(n),
where n is the current time step. It is assumed that the time steps are equally spaced, and that at all times prior to the first step the “observed” values are 0. Any consecutive M observations can be used as filter input, represented by the input vector
u^{T}(i)=[u(i),u(i−1), . . . , u(i−M+1)] (1.1)
where the symbol u^{T} means the transposed column vector u.

The filter itself is an M-by-1 matrix (vector), the value of which is at time n given by the weight vector
w^{T}=[w₁(n),w₂(n), . . . , w_{M}(n)] (1.2)

The filter is a linear filter, which means that it operates linearly upon any input vector u (i), for 1≦i≦n. More precisely, let A(n) denote the data matrix

$$\begin{matrix}{A}^{ T} [ u ( 1 ) , u ( 2 ) , … , u ( n ) ] = \\ [ \begin{matrix}u ( 1 ) & u ( 2 ) & ⋯ & u ( M ) & ⋯ & u ( n ) \\ 0 & u ( 1 ) & ⋯ & u ( M - 1 ) & ⋯ & u ( n - 1 ) \\ ⋮ & ⋮ & ⋮ & ⋮ & ⋮ & \\ ⋮ & ⋮ & ⋮ & ⋮ & ⋮ & \\ 0 & 0 & ⋯ & u ( 1 ) & ⋯ & u ( n - M + 1 )\end{matrix} ]\end{matrix} \qquad ( 1.3 )$$

where A^{T} denotes the transpose of A. The null entries in the lower left corner are the effect of what Haykin calls “pre windowing”, i.e., setting observations prior to the first time step equal to zero.

To show the linear applications of the filter and its effect relative to d(i), which is the desired output for the ith time step (in the this case the prediction of the air fluctuation) of the filter, the estimation error e(i) is defined as
e(i)=d(i)−w^{T}(n)·u(i)=d(i)−w^{T}(n)·(A^{T})ᵢ (1.4)
where (A^{T})ᵢ is the ith column of A^{T}, and set the cost function E(n) to be

$$E ( n ) = {\sum }_{i = 1}^{n} {λ}^{n - i} {\vert ⅇ ( ⅈ ) \vert}^{2} \qquad ( 1.5 )$$

where λ is an exponential weighting factor (sometimes called the “forgetting” factor): 0<λ≦1. It is clear that for small values of λ the effects of recent observations on the cost function are much greater than early observations. Thus λ determines the rate at which the filter can adapt to changing trends in the data. The quantity 1/(1−λ) is called the memory of the filter.

The values of d(i) in Eq. 1.4 are the measured values of past interferometer fluctuations, not past predictions. Therefore d(i) at time step i will involve contributions from past interferometer fluctuations earlier than time step i. For example, if d(i) represents a prediction of u(i) k time steps in the future, the most recent interferometer measurement contributing to the filter estimate of d(i) will be u(i−k). The filter is determined by the condition that the weights of w(n) are selected to minimize E(n). This is a standard least squares analysis problem. The unknown weight vector w^{T}(n) is determined in principle by substituting Eq. 1.4 into Eq. 1.5, setting derivatives of E(n) with respect to the unknown wᵢ(n)'s equal to zero and solving the resulting linear equations for the wᵢ(n)'s. However this is computationally inefficient, because the matrix A=A(n) increases in size with each increment in time.

Therefore the data matrix A is not actually used in these calculations; it was introduced for pedagogical reasons. Instead the QRD-RLS algorithm operates recursively, which means that it takes the input vector u(i) and the corresponding value of d(i) at each time and combines them with the current value of w to produce an updated value of w. This implies that w changes at each recursion; in other words, it is a function of n. The recursion greatly reduces calculation and storage requirements; a non-recursive technique would require solving n linear equations in M unknowns, where n increases each time a new data point is obtained.

The algorithm creates an M×M storage matrix R(n) and a 1×M column vector p(n) which contains information about previous desired values d(i). Explicit expressions for R(n) and p(n) are given in Chapter 14 of the book by Haykin. The specific numerical procedure used to obtain R(n) employed a “fast Givens” least squares projection which is described in a paper by James Minor, GADS—Generalized Analysis of Discrete Data, DuPont Engineering Report, accession number 16973, incorporated in its entirety herein by reference for all purposes. The weights w(n) are determined by solving the matrix equation
R(n)·w(n)=p(n) (1.6)

R(n) is an upper diagonal matrix, where all elements below the main diagonal are zero. This allows w(n) to be determined simply by back substitution. Unique values of w(n) depend on the columns of R(n) being linearly independent. This is equivalent to requiring that the elements on the diagonal be non-zero. If some diagonal elements are zero or very small, because of numerical inaccuracies, the solution can become unstable. This is avoided by using a regularization (ridge-regularization) procedure which adds a small positive term to each diagonal element. The terms provide stability but are small enough that they have negligible effect on the values of w(n). The ridge regularization procedure is described in the paper by Minor referenced above. It allows determination of the w(n) even when the rank of R(n) is less than M. The procedure of singular value decomposition (SVD) may also be used to obtain the w(n). SVD is described in e.g. H. Martens and T. Naes, Multivariate Calibration, John Wiley, NY, 1989, incorporated in its entirety herein by reference for all purposes. However, SVD is much more expensive to compute versus Givens, and adaptive moving-average applications would require much more complication. SVD still suffers from quasi-zero values on its diagonal requiring ridge-regularization to resolve.

From the above, it is clear that only a limited number of past values of the electrical signals need to be stored. In the example above, only the M most recent values need to be stored. As a modification of this embodiment, instead of determining the weights from the M most recent signal values, a set of M values, each separated by m units of time, may be used. In this case a total of (Mm+1) values need to be stored. Each time a new value is added to storage, the oldest value is removed.

In the present case the u(i) are digitally sampled interferometer signals, and the desired values d(i) are future interferometer signals. For example, if it is desired to predict the interferometer signal k sampling periods in the future, d(i) represents the prediction of the interferometer signal u(i+k).

We have verified that interferometer fluctuations can be predicted. We measured the signal fluctuations from an interferometer of fixed optical path length, which were caused by fluctuations in air temperature along the optical path. The standard deviation of the signal, measured over a period of 8 minutes, was 3.03 nm. A linear adaptive filter consisting of three terms was trained on an initial sample of data and then used to predict the interferometer signal for several times into the future. The residual error, the difference between the predicted signal and the real signal at the same time, would be zero for perfect predictions. The standard deviation of the residual error was 0.46 nm for predictions of 31 msec into the future, and 1.1 nm for predictions of 250 msec into the future. These standard deviations are significantly smaller than the standard deviation of the original uncorrected signal. Thus successful predictions of interferometer fluctuations are possible.

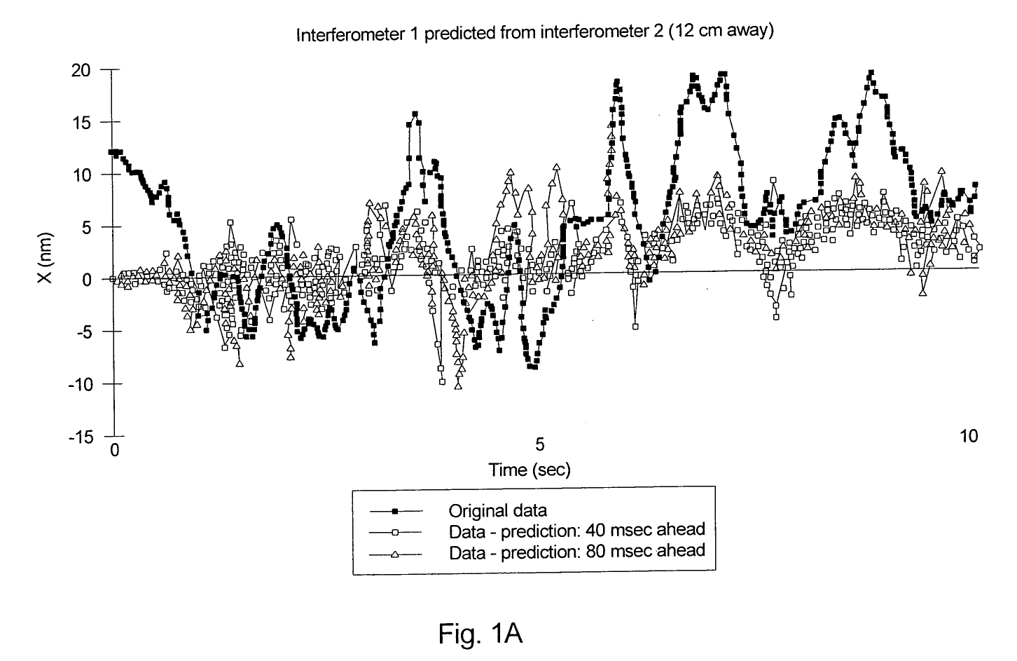

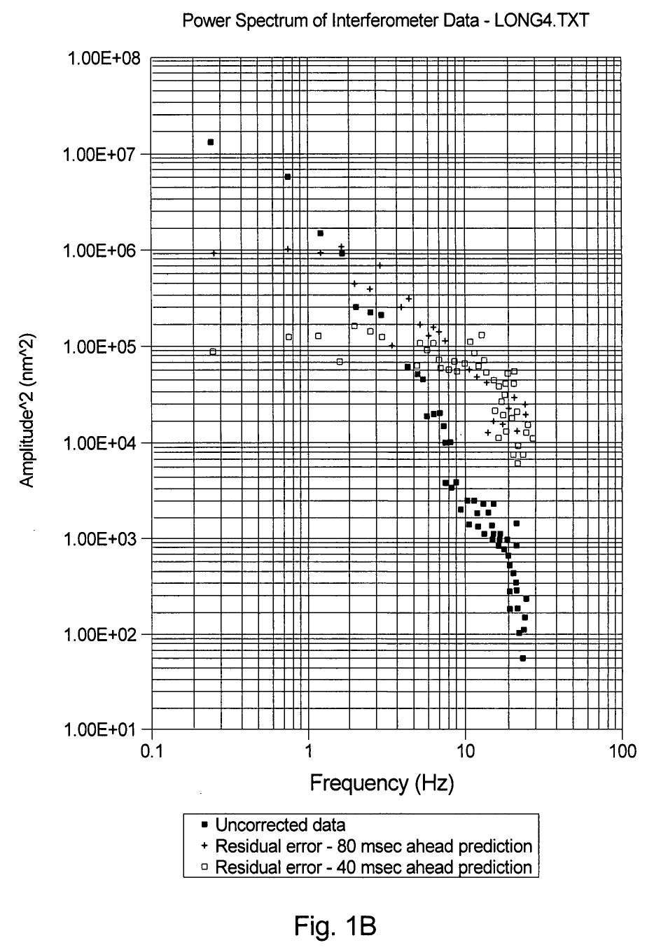

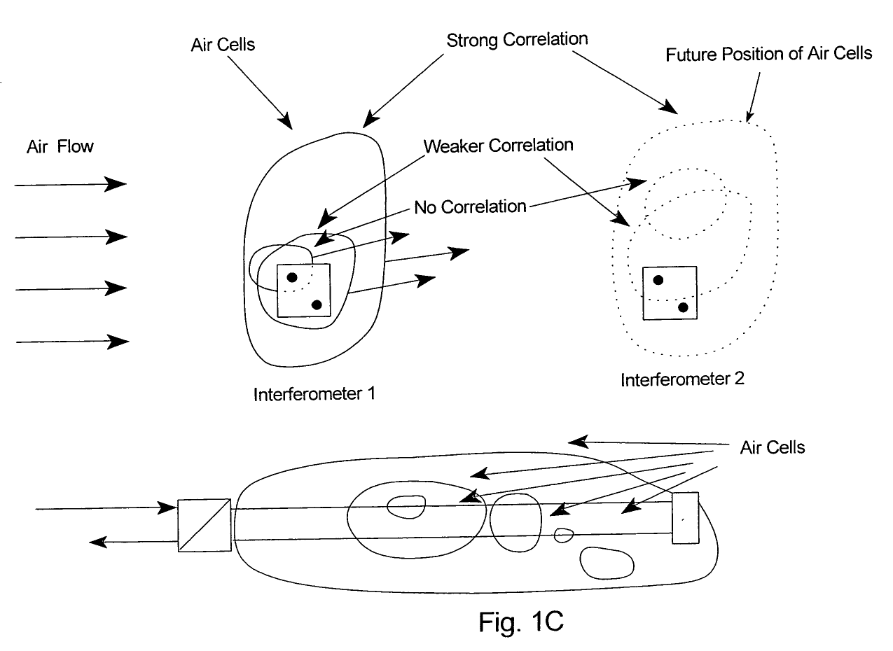

In another experiment, we directed a flow of air across the optical paths of two interferometers of fixed optical path length, which were aligned parallel to one another and of a fixed length. The optical path length was 30 cm and the optical paths were separated by 12 cm. The upstream interferometer (Interferometer 2) signal was used to predict the fluctuations in the downstream interferometer (Interferometer 1) signal. The predictions were made using a linear adaptive filter. The signal processing and prediction details will be described in detail below. FIG. 1a shows the signal from Interferometer 1 over 10 sec. The fluctuations, caused by fluctuations in the air temperature along the optical path, had a value of 3σ=19.9 nm, where σ is the standard deviation of the signal. Also shown are the residuals between the interferometer signal and the fluctuation predictions made from Interferometer 2, for prediction times of 40 msec and 80 msec into the future. That is, the latter signals represent corrected measures of the interferometer path length. The fluctuations are reduced to 3σ=7.1 nm for the 40 msec predictions and 11.9 nm for the 80 msec predictions. Thus the predictions of the fluctuations are reasonably successful.

FIG. 1b shows the interferometer signal power spectra of the original interferometer 2 data and the predicted residuals. The power law fall-off of the interferometer 2 spectral amplitudes with increasing frequency is typical of classical Kolmogorov air turbulence. FIG. 1b also shows that the predictions are best at low frequencies. If the Interferometer 2 signal had been low pass filtered, with a frequency cutoff at approximately 4-5 Hz, and predictions made using only the lower frequency components, the predictions would lose the high frequency noise seen in FIG. 1.1, and the residual fluctuations would be much smaller. For the case of the 40 msec predictions, we found that the fluctuations of the residuals would be reduced to 3σ=4.4 nm, a significant improvement. While this would mean abandoning any attempt at predicting higher frequency interferometer fluctuations, the power spectra show that an overwhelming majority of the signal power is contained in the low frequencies, so this restriction would have little effect on the ultimate performance of this application.

A physical picture which probably explains the above results is given in FIG. 1c. Shown are two interferometers which measure the fixed distance between the interferometer head and a fixed reflector. The interferometer heads are shown schematically and represent a double pass interferometer, in which the interferometer beam makes two round trips between the interferometer head and the reflector. Turbulent mixing creates cells of air of different temperatures, which are blown through or near the interferometer beam paths. The cells which blow through both beam paths can be successfully predicted in principle, assuming that their shape and temperature don't change appreciably during the transit time. This is referred to as the Taylor hypothesis in turbulence theory. Cells which miss one of the beams obviously can't be predicted. Larger cells are more likely to intercept both beams, and they will naturally correspond to lower frequency components in the interferometer power spectra. Smaller cells are more likely to miss one of the interferometer beams, and they represent the higher frequency components of the interferometer power spectra, which, as we have seen, are less successfully predicted.

These results provide a proof of concept demonstration that prediction of interferometer fluctuations is possible.

We also confirmed that the source of the fluctuations was fluctuations in air temperature along the interferometer optical path. We installed an air temperature sensor consisting of a very thin wire in place of the second interferometer described above. The wire was approximately as long as the interferometer optical path length. The resistance of the wire is related to its temperature, and changes in local air temperature change the resistance of the wire. The equivalence of these measurements of wire resistance to measurements of changes in optical path length is described in e.g. a paper by K. Abdel-Khadi et al in Soviet Journal of Quantum Electronics, Vol. 6, 660 (1976), incorporated in its entirety herein by reference for all purposes. We found that predictions of the fluctuations in the first interferometer could be made as successfully with the air temperature sensor as with the second interferometer.

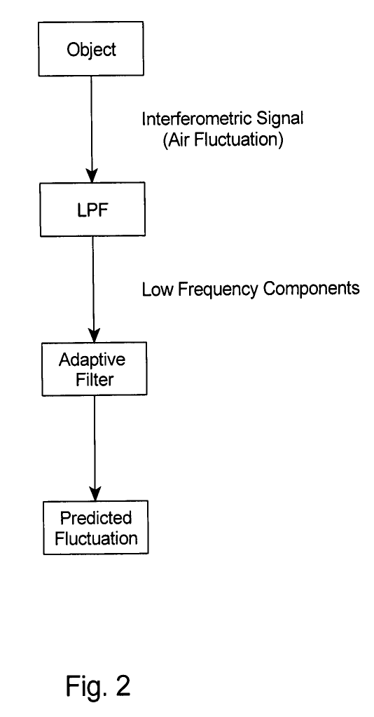

FIG. 2 schematically shows the prediction method of the first embodiment described above. The system measures a distance from a reference point, for example the distance between the interferometer and a stationary object. The interferometric signal reflected from the object would be a constant value if there were no air fluctuations at all along the interferometric beam path. In reality, however, air fluctuations are present and give rise to the fluctuations of the interferometric signals, resulting in problems such as reduced accuracy of the measurement. To correct for this the interferometric signal is low-pass filtered to remove high frequency components of the signal so that the high frequency noises do not deteriorate the performance of the linear adaptive filter. In this embodiment, a cutoff frequency of 5 Hz was chosen. Then, the signal is fed to the linear adaptive filter to predict future signal fluctuations based on the results of the past predictions and measurements. Predictions have been made 40 and 80 msec into the future. In the above example, fluctuations in one interferometer beam path were used to successfully predict fluctuations in an adjacent beam path using this method, an even more challenging situation.

2. Making Predictions for a Moving Stage

For the case of a moving stage, where the interferometer beam path length is constantly changing, the method described in section 1, in certain cases, is not entirely adequate, because it is impossible to separate changes due to stage motion from those due to air fluctuations. However the linear adaptive filter described above can presumably make successful predictions, provided some way to measure the fluctuations is found so that the cost function in Eq. 1.5 can be constructed. A method for doing this will be described below as a second embodiment.

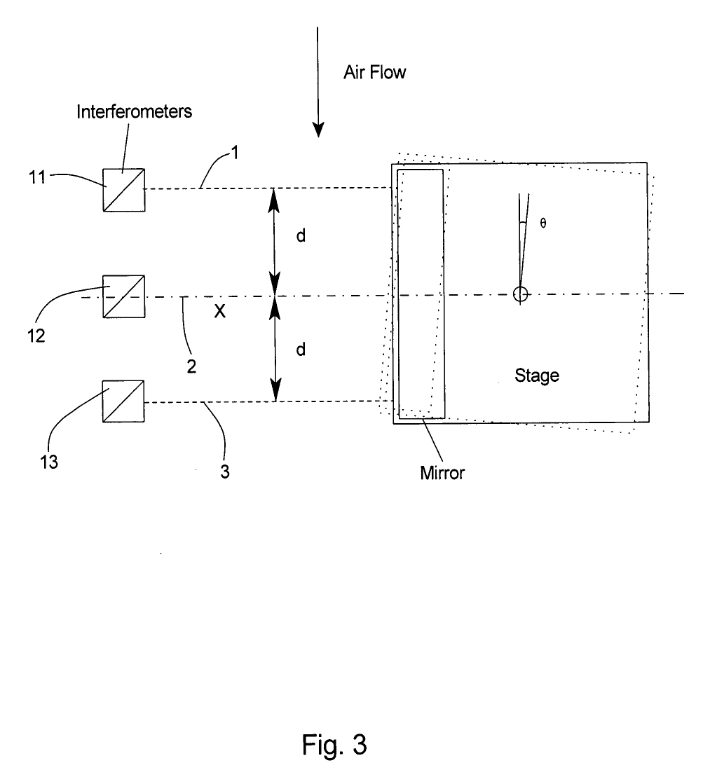

Consider a stage capable of one-dimensional motion moving in an X direction. The stage may also exhibit a small amount of yaw, rotation of the stage about a vertical axis. We use the interferometer system shown in FIG. 3. The stage X position is measured by 3 parallel interferometer beam paths 1, 2, 3, which measure the distance between the interferometer heads and a plane mirror mounted on the stage. For simplicity it is assumed that the beams are separated by equal distances d. Also, any stage yaw occurs about a vertical axis lying in a plane passing through the central interferometer beam. These assumptions are not essential to the following, but simplify the algebra.

The interferometer beam paths 1, 2, 3 experience a transverse current of air flowing from interferometer 11 to interferometer 13. The interferometer signals at a time t can then be represented as
I₁=X+dθ+δ₁
I₂=X+δ₂
I₃=X−dθ+δ₃ (2.1)
where X is the true stage position, θ is the stage yaw angle, and δ₁, δ₂, and δ₃ are the air fluctuations in the three interferometer beam paths 1, 2, 3, respectively. Then a new quantity DX can be defined as
DX=I₁+I₃−2I₂=δ₁+δ₃−2δ₂ (2.2)

The significance of DX is that it depends only on the air fluctuations. The stage motions, translation and yaw, are completely eliminated. If a local air flow blows from the interferometer 11 to interferometer 13, DX can be used with a linear adaptive filter to make predictions of the future fluctuations of I₁, I₂, and I₃.

If the interferometer beams are not equally spaced, a linear combination of the beam signals can still be formed which is independent of stage motion and depends only on the air fluctuations. If I₁ and I₂ are separated by a distance d₁, and I₂ and I₃ are separated by a distance d₂, and the yaw contribution is again zero at the position of I₂, the quantity
DX′=I₁/d₁+I₃/d₂−I₂(1/d₁+1/d₂)=δ₁/d₁+δ₃/d₂−δ₂(1/d₁+1/d₂), (2.2a)
satisfies these conditions. For the case d₁=d₂=d, Eq. 2.2a reduces to the quantity DX/d.

It was found that DX itself can be successfully predicted. However it may seem unlikely that DX has enough information to make such predictions for the individual interferometers. The following model suggests that it should be possible in principle.

Assume the fluctuations are caused by cells of turbulent air coming from the local air conditioning duct and traveling at velocity v, the mean velocity of the duct air flow. Also assume the cells do not change shape or properties significantly in the time it takes for them to pass through the beams (Taylor hypothesis in turbulence theory). Then, if the fluctuation of I₁ at time t is given by f(t), the fluctuation of I₂ is f(t−Δt) and the fluctuation of I₃ is f(t−2Δt), where Δt=w/v. Therefore,

$$\begin{matrix}DX ( t ) = f ( t ) + f ( t - 2 Δ t ) - 2 f ( t - Δ t ) \\ \approx {f}^{″} ( t ) {( Δ t )}^{2} .\end{matrix} \qquad ( 2.3 )$$

where f′(t) represents the second derivative of f(t). In fact, for some value of time t′ in the range t≧t′≧t−2Δt, the equality holds:
DX(t)=f′(t′)(Δt)². (2.4)

DX(t) is updated after every sampling interval δt, where δt<Δt. The sampling frequency is much higher than the frequencies associated with air turbulence, so δt is much shorter than the transient time for f(t).

A double integration on 2.4 produces f(t). This is achieved by the following numerical sum:

$${\sum }_{j = 1}^{m} {c}_{j} {\sum }_{i = 1}^{j} {c}_{i} DX ( {t}_{i} ) = [ {\sum }_{j = 1}^{m} {c}_{j} {\sum }_{i = 1}^{j} {c}_{i} {f}^{″} ( {t}_{i}^{′} ) {( δ t )}^{2} ] {( \frac{Δ t}{δ t} )}^{2} -> {( \frac{Δ t}{δ t} )}^{2} \int \int {f}^{″} ( {t}^{′} ) {( ⅆ {t}^{′} )}^{2} \qquad ( 2.5 )$$

where the cᵢ, cⱼ are the coefficients used for numerical integration (e.g. for Simpson's rule, cⱼ=1/3, 2/3 or 4/3, depending on the index value). The indices are defined here such that i=1 corresponds to the most recent measurement, and j=m is the “oldest” measurement used in the calculation.

The integral in Eq. 2.5 is just
∫∫f″(t′)(dt′)²=f(t₁′)+a(t₁−tₘ)−f(tₘ) (2.6)
where a is an integration constant, and f(tₘ) was determined during an earlier application of this procedure. The constant a is equal to 0, since the fluctuations do not increase linearly with time.

It is seen from Eqs. 2.5 and 2.6 that it is possible to relate the fluctuation f(t) at the present time to a summation over the measured DX's, and of course earlier values of f(t) are obtained by the same technique. It is now possible to predict f(t) by using a linear adaptive filter as described earlier. If the future time is taken as t₀, f(t₀) can be written as

$$f ( {t}_{0} ) = {\sum }_{k = 1}^{m} {W}_{k} f ( {t}_{k} ) \qquad ( 2.7 )$$

where the Wₖ are the linear adaptive filter weights. Substituting from Eqs. 2.5 and 2.6 and rearranging terms gives

$$\begin{matrix}f ( {t}_{0} ) = {\sum }_{k = 1}^{m} {W}_{k} f ( {t}_{k} ) \\ = {\sum }_{k = 1}^{m} {W}_{k} \{ {( \frac{δ t}{Δ t} )}^{2} {\sum }_{j = 1}^{m} {c}_{j} {\sum }_{i = 1}^{j} {c}_{i} DX ( {t}_{i} ) - f ( {t}_{m} ) \} \\ ≡ {\sum }_{k = 1}^{m} {w}_{k} DX ( {t}_{k} ) + Bias Term ,\end{matrix} \qquad ( 2.8 )$$

which is now in the same form as the linear adaptive filter, and the wₖ and the Bias Term are defined by this relationship. The Bias Term represents long term drift and other contributions not represented by the DX variable; they will be discussed below.

Thus predictions of f(t) are generated from the measurements of DX, and from the initial assumptions above it is known that I₁=f(t), I₂=f(t−Δt), and I₃=f(t−2Δt). Therefore, in principle, the individual interferometer fluctuations can be predicted from measurements of the variable DX. This relationship has been confirmed experimentally.

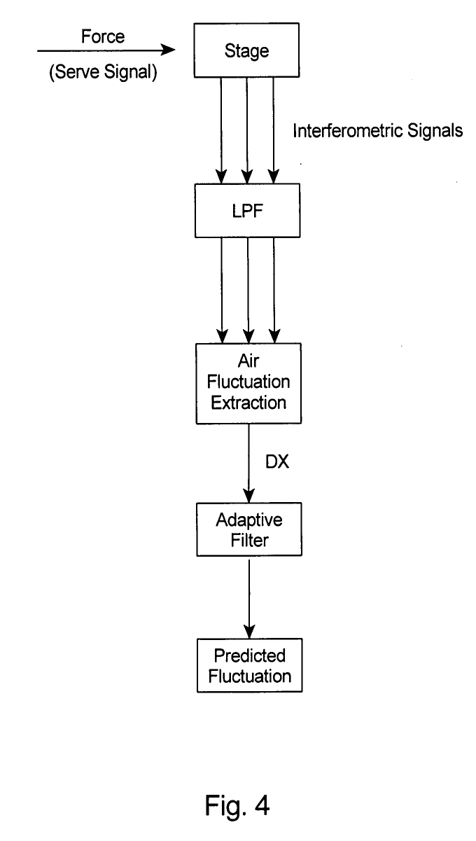

FIG. 4 schematically shows the prediction method of the second embodiment described above. The system locates positions of a moving stage. The stage is driven by a force applied by an actuator device (not shown in the figure) in response to a servo signal. Each of the three interferometers receives an interferometric signal in response to the stage movement and feeds the raw signal to a low-pass filter the cutoff frequency of which is about 10 Hz, for example. The filtered signals are combined to extract the mutual signal fluctuation due to the air fluctuation (DX). The linear adaptive filter then uses the mutual signal fluctuation to predict the signal fluctuations of the interferometers at some time in the future. Previous predictions of the fluctuations and the actual measured fluctuations of the interferometers are used in this process. The assumption here is that the shape and temperature of the cell regions of different temperature do not change appreciably while they pass through the three beam paths of the interferometers. It is also possible to perform the low-pass filtering immediately before the linear adaptive filter process, rather than before the mutual signal fluctuation extraction.

When extremely high accuracy is required, predictions of δ₁, δ₂, and δ₃ using only information about DX may not be satisfactory. There are enough changes in the turbulent cells moving across the interferometer beam paths that separate linear adaptive filters may be needed for each interferometer. Also, as described below, some low frequency stage motions, as well as yaw, are correlated with some interferometer fluctuations. These correlated motions affect the δᵢ's but not DX, so DX alone cannot provide a complete description. In addition it is desirable to determine the individual δᵢ's. In a third embodiment, a following error FE1 is defined as FE1=I₁−CMD, where CMD is the desired stage location specified by the stage servo system. In the absence of stage servo error, FE1=0, but air fluctuations can still cause absolute stage position error. In this embodiment, the other contributions to FE1 are estimated using an algorithm which is described below. Similar following errors are defined for the other interferometers. This embodiment will be described with a servo system which controls stage position with FE2 and does not control yaw.

The variable DX is still valuable, because it represents information purely about air fluctuations. Because of their origin, the quantities δ₁, δ₂, and δ₃ are likely to retain some residue of stage motion, which represents an intrinsic error in the predictions. An adaptive moving average algorithm was created to remove residual stage motion effects. This algorithm uses moving averages, whose durations are adaptive, to estimate relatively low frequency residual stage motion and yaw remaining in the interferometer following errors. Higher frequency components of the stage motion are removed by low pass filters later.

The residual stage motion δ_{stage} and yaw δ_{yaw} are estimated by an adaptive moving average algorithm. δ_{stage} and δ_{yaw} are estimated by successive approximations. The first estimates are
δ_{stage,1}=(FE1+FE2+FE3)/3 (2.9)
δ_{yaw,1}=(FE1−FE3)/2 (2.10)

These approximations include the air fluctuations of course:
δ_{stage,1}=(FE1_{stage}+FE2_{stage}+FE3_{stage})/3+(δ₁ₐᵢᵣ+δ₂ₐᵢᵣ+δ₃ₐᵢᵣ)/3 (2.11)
δ_{yaw,1}=(FE1_{stage}−FE3_{stage})/2+(δ₁ₐᵢᵣ−δ₃ₐᵢᵣ)/2, (2.12)
where FE1_{stage}, FE2_{stage}, and FE3_{stage} represent real residual stage motion.

These estimates can be improved by using moving averages and combining information about the stage position, velocity, and acceleration. For example, if the stage remains at rest, then over time the fluctuations will average out. However, since the stage will usually be moving, the moving averages must be adapted to the stage motion; the time over which the averaging occurs must be shorter. Also the data used in the estimation should be consistent with stage motion. This means that the first and second time derivatives of the stage position (i.e. velocity and acceleration estimates) should be continuous, and the third derivative (“jerk”) should be essentially zero, except briefly during stage acceleration and deceleration. Higher derivatives should be zero except when the jerk is changing. Furthermore, acceleration should be essentially zero when the stage moves at constant velocity.

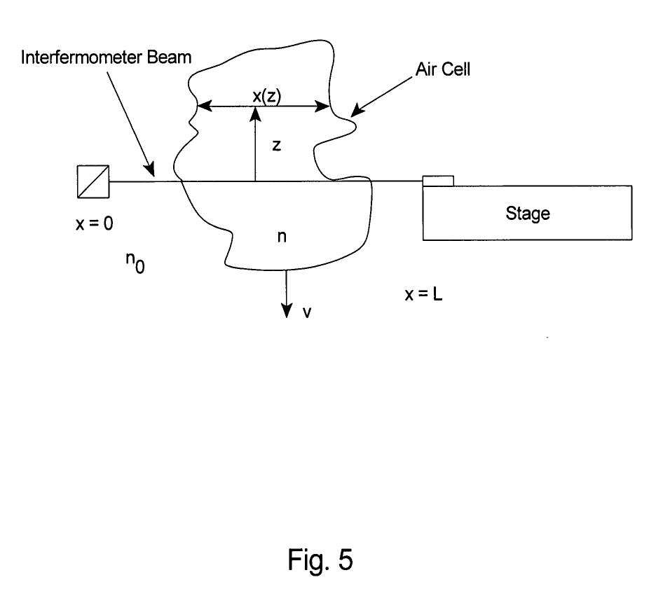

These properties help distinguish stage motions from air fluctuations. Interferometer signals caused by air fluctuations will also have continuous time derivatives, but second and third derivatives may be large independently of stage motion, and higher order derivatives may also be significant, as illustrated in FIG. 5. An air cell passing through the interferometer beam can create significant higher order derivatives of the interferometer signal, if its shape is complicated. However, separating stage motions from air fluctuations by this method will never be 100% effective.

In order to further refine the extraction of the interferometer air fluctuations in the presence of low frequency stage motion, the stage motion estimates are included in the linear adaptive filter cost function. Included in the assumption is the additional information that stage motion is characterized by identical changes in all three interferometers, and yaw is characterized by equal and opposite contributions to I₁ and I₃. Then, the linear adaptive filter cost functions are rewritten as

$$\begin{matrix}{E}_{1 , n - m} ≡ {\sum }_{i = 1}^{n - m} {{λ}^{n - m - i} [ δ {I}_{1 , i + m} - α {δ}_{stage} - {βδ}_{yaw} - \underline{{w}_{1}} ( n ) \cdot \underline{DX} ( i ) ]}^{2} & ( 2.13 ) \\ {E}_{2 , n - m} ≡ {\sum }_{i = 1}^{n - m} {{λ}^{n - m - i} [ δ {I}_{2 , i + m} - {αδ}_{stage} - \underline{{w}_{2}} ( n ) \cdot \underline{DX} ( i ) ]}^{2} & ( 2.14 ) \\ {E}_{3 , n - m} ≡ {\sum }_{i = 1}^{n - m} {{λ}^{n - m - i} [ δ {I}_{3 , i + m} - {αδ}_{stage} + {βδ}_{yaw} - \underline{{w}_{3}} ( n ) \cdot \underline{DX} ( i ) ]}^{2} . & ( 2.15 )\end{matrix}$$

α and β are obtained when the cost functions are simultaneously optimized. If the estimates δ_{stage,est} and δ_{yaw,est} are accurate, then α and β should be about 1.0. Each time the weight estimates are updated, i.e. when n→n+1, the estimates for δ_{stage} and δ_{yaw} are also updated. Note that the bias term was removed. This term was originally added to handle possible problems with drift. However low frequency drift can't be handled with the above cost functions, because the variable DX is essentially zero for that case. Low frequency drift can be included using a temperature sensor as shown below.

The above information based on the dynamics of a rigid body is combined as follows. If our best estimates at time t of position, velocity, and acceleration are xₜ, vₜ, and aₜ respectively, then the best estimate of position at time t+Δt should be
xₜ+Δt=xₜ+vₜΔt+(½)aₜΔt² (2.16)

In Eq. 2.16 Δt represents the sampling time interval. It is not the same Δt as used in Eq. 2.3. These ideas, plus the recursive relations used to efficiently carry out the moving averages, are described below briefly for the case of stage yaw estimation. In the following, stage yaw was not under servo control. Some changes are then described in order to apply this formalism to the case of stage motion, where servo control is present.

The stage yaws because of unbalanced forces, such as friction or cable drag, which are unpredictable. The adaptation used to estimate stage yaw must be fairly sophisticated, because the time constants associated with the yaw cover a wide dynamic range. For example, when the stage is at rest it does not yaw, so the adaptation should be very slow. When the stage starts moving however, large yaws (I1−I3≈100 nm in this embodiment) can occur in less than 1 sec, so adaptation must now be very fast. After the stage stops, it sometimes rotates a small amount over several seconds, probably from cable drag. Adaptation must then occur over several seconds. These considerations are incorporated in the description below.

Represent the first estimates, Eqs. 2.9 or 2.10, at time t by zₜ. The sequence of estimates is separated by the time interval Δt. If time is measured in units of Δt, then the function z at times t−Δt and t+Δt will be represented as zₜ₋₁ and zₜ₊₁, respectively. A better estimate of z at t+1 is intended, based on moving averages of earlier data. Time t+1 is assumed to be the present time.

Instantaneous estimates of angular position μ, velocity ν, and acceleration α of the stage are defined as follows:
μₜ=(zₜ₊₁+Zₜ+Zₜ₋₁)/3 (2.17)
νₜ=(zₜ₊₁−Zₜ₋₁)/2 (2.18)
αₜ=(zₜ₊₁−2Zₜ+Zₜ₋₁)/6 (2.19)

Zₜ and Zₜ₋₁ are best estimates of z at earlier times. When these relations are first used the best estimates are not known, so Zₜ=zₜ and Zₜ₋₁=zₜ₋₁ are initially used.

Adaptive moving averages are now performed on μₜ, νₜ, and αₜ as follows.

1) Moving average on the angular acceleration. Two quantities are defined recursively:

$$\begin{matrix}{S}_{t + 1}^{α} = {α}_{t} + {c}^{α} {S}_{t}^{α} & ( 2.20 ) \\ {Q}_{t + 1}^{α} = 1 + {c}^{α} {Q}_{t}^{α} . & ( 2.21 ) \\ Then & \\ {Z}_{t + 1}^{α} = \frac{{S}_{t + 1}^{α}}{{Q}_{t + 1}^{α}} & ( 2.22 )\end{matrix}$$

is the best estimate of angular acceleration at time t+1. Quantity c^{α} is a constant.

That Eq. 2.19 represents a moving average can be seen by expanding the recursive relation:

$${Z}_{t + 1}^{α} = \frac{{α}_{1} + {c}^{α} {α}_{t - 1} + {( {c}^{α} )}^{2} {α}_{t - 2} + {( {c}^{α} )}^{3} {α}_{t - 3} + …}{1 + {c}^{α} + {( {c}^{α} )}^{2} + {( {c}^{α} )}^{3} + …} \qquad ( 2.23 )$$

This is clearly a weighted average, and if c^{α}<1 only a limited number of past values of α will contribute.

Choosing c^{α} to be a constant means that the rate of change of angular acceleration does not change much over time. This is an assumption, but it has worked well in practice. The constant c^{α} can be a variable, as shown below, if necessary.

2) Moving average on the angular velocity. Analogously to the above, the following are defined:

$$\begin{matrix}{S}_{t + 1}^{v} = {v}_{t} + {c}^{v} ( \vert {Z}_{t + 1}^{a} \vert ) {S}_{t}^{v} & ( 2.24 ) \\ {Q}_{t + 1}^{v} = 1 + {c}^{v} ( \vert {Z}_{t + 1}^{a} \vert ) {Q}_{t}^{v} & ( 2.25 ) \\ and & \\ {Z}_{t + 1}^{v} = \frac{{S}_{t + 1}^{v}}{{Q}_{t + 1}^{v}} & ( 2.26 )\end{matrix}$$

Note that c^{ν} is now a function of the acceleration estimate Zᵢ₊₁^{α}. A sigmoidal functional form is used:

$$\begin{matrix}{c}^{v} ( \vert {Z}_{t + 1}^{a} \vert ) = {L}^{v} + \frac{{U}^{v}}{1 + exp [ {a}^{v} ( {\vert {Z}_{t + 1}^{a} \vert}^{2} - {b}^{v} ) ]} ; & \vert {L}^{v} + {U}^{v} \vert \leq 1\end{matrix} \qquad ( 2.27 )$$

Thus, when Zₜ₊₁^{α} is small (low acceleration), c^{ν}(|Zₜ₊₁^{α}|) is relatively large, and the averaging can extend over a long time period. When Zₜ₊₁^{α} is large (high acceleration→rapid velocity change), c^{ν}(|Zₜ₊₁^{α}|) can be much smaller (depending on the relative values of L^{ν} and U^{ν}), the averaging will be limited to just a few terms, and the velocity estimate can change relatively rapidly.

3) Moving average on the angular position:

$$\begin{matrix}{S}_{t + 1}^{μ} = {μ}_{t} + {c}^{μ} ( \vert {Z}_{t + 1}^{v} \vert ) {S}_{t}^{μ} & ( 2.28 ) \\ {Q}_{t + 1}^{μ} = 1 + {c}^{μ} ( \vert {Z}_{t + 1}^{v} \vert ) {Q}_{t}^{μ} \\ and & ( 2.29 ) \\ {Z}_{t + 1}^{μ} = \frac{{S}_{t + 1}^{μ}}{{Q}_{t + 1}^{μ}} & ( 2.30 )\end{matrix}$$

Again, c^{μ}(|Zₜ₊₁^{ν}|) is a sigmoidal function, this time depending on the angular velocity estimate:

$${c}^{μ} ( \vert {Z}_{t + 1}^{v} \vert ) = {L}^{μ} + \frac{{U}^{μ}}{1 + exp [ {a}^{μ} ( {\vert {Z}_{t + 1}^{v} \vert}^{2} - {b}^{μ} ) ]} \qquad ( 2.31 )$$

The parameters in the sigmoidal functions are determined in an optimization procedure.

The best estimate of yaw is then defined, following Eq. 2.13, as
Zₜ₊₁=Zₜ₊₁^{α}Δt²+Zₜ₊₁^{ν}Δt+Zₜ₊₁^{μ} (2.32)

There is no factor of ½ in front of the acceleration term because of the way αₜ was defined (Eq. 2.19).

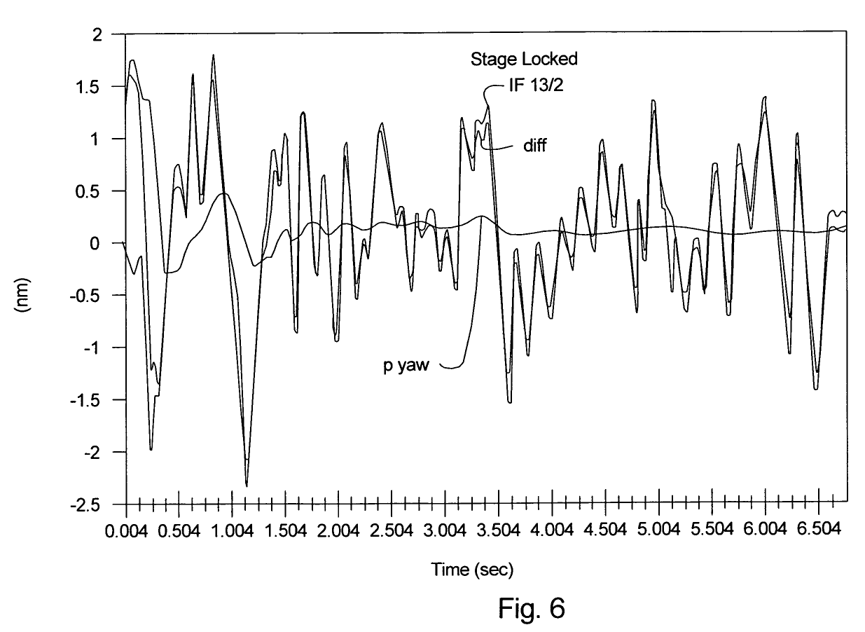

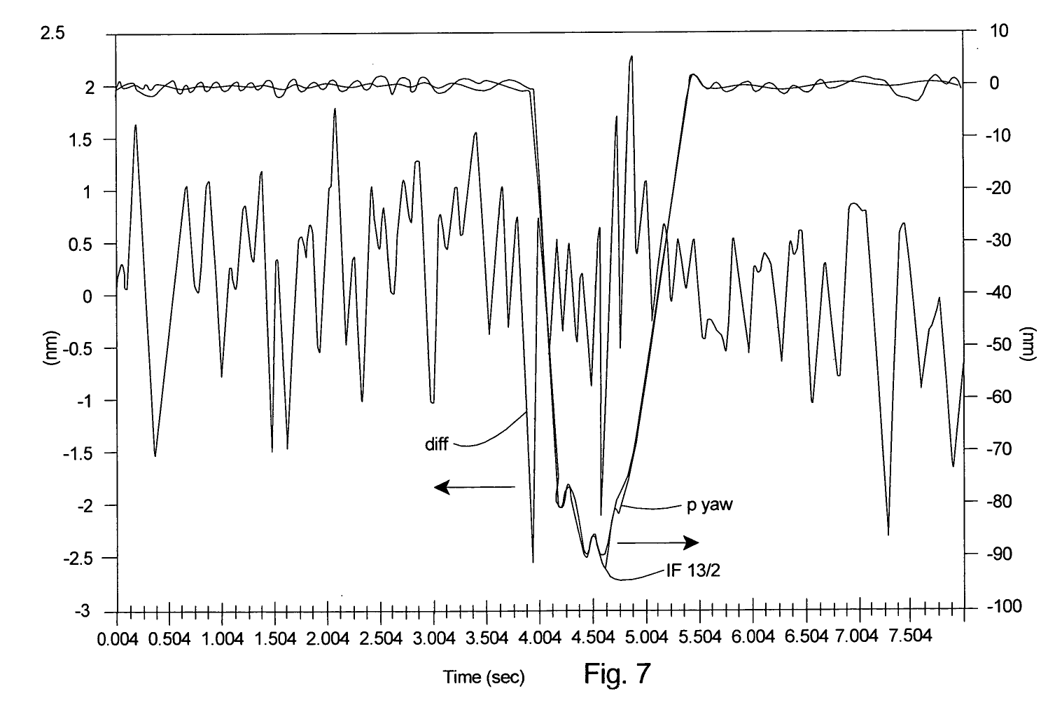

The performance of the adaptive moving average algorithm for stage yaw is demonstrated in FIGS. 6 and 7. In the figures, IF13/2≡(I1−I3)/2. In FIG. 6, the stage is locked down, so stage conditions are static and no yaw should occur. After initial transients, lasting approximately 1 sec., while the algorithm adapts to the static condition, the yaw estimation (labeled p yaw) settles down to an almost constant value. The curve labeled diff represents contributions from the “antisymmetric” part of the air fluctuations (δ₁=−δ₃) which we cannot separate out, and the unknown error of the algorithm itself. Taking diff as the upper limit to the algorithm error, the rms error after low pass filtering is 0.72 nm. In FIG. 7 the stage is moving and significant yawing (≈90 nm) occurs. Now the algorithm adapts rapidly. The rms upper limit to the algorithm error after low pass filtering is about 0.75 nm. Thus the adaptive moving average is successful in identifying and removing almost all of the yaw signal.

The same basic approach is used for the stage position motion estimation. However, there are some differences. Instead of the actual stage position the following errors are used. This means that most of the effects of stage motion have been removed already. This reduces the need somewhat for adaptive control of the moving average. In the above derivation for the yaw motion, no yaw servo was assumed, so no yaw CMD signal was available to use for this purpose. Since the position CMD signal is available, and its derivatives, i.e. velocity, acceleration, and jerk, can be calculated, the system always knows when an acceleration is about to occur, and can adjust the adaptation appropriately. Such information was not available for the yaw signal. During stage acceleration and deceleration the servo cannot completely keep up with the CMD signal (servo signal), and the following error becomes larger. During these periods the adaptation becomes important.

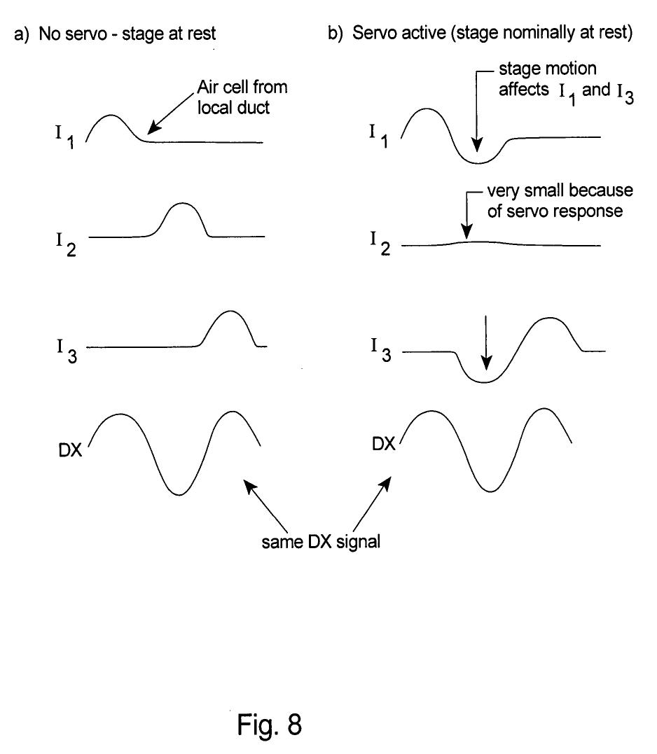

Depending on the servo properties, some low frequency stage motion may be strongly correlated with some of the air fluctuations, which will affect the above filter's performance. For example, suppose the servo is controlled by the following error associated with interferometer 2 and that for the low frequencies of interest here the servo gain is high enough that the following error is very small. Then if δ_{stage} represents a stage motion error, the following error becomes FE=δ_{stage}+δ₂≈0, or δ_{stage}≈−δ₂, so in this case the stage motion is closely correlated to δ₂. This stage motion will obviously affect the fluctuations of interferometers 1 and 3 as well. However, as demonstrated in FIG. 8, DX is not affected whether the servo is on or off. By construction DX is unaffected by stage motion.

As a result of the correlated stage motion, the initial estimate of the stage motion, Eq. 2.9, becomes
δ_{stage,1}=(FE1+FE2+FE3)/3=(δ₁−δ₂+0+δ₃−δ₂)/3=DX/3 (2.33)

The parameters describing the adaptive coefficients are trained from stage interferometer data obtained under a number of conditions. The stage is locked down (servo off) and the variable DX/3 is used. Next the stage is servoed at rest and the coefficients are trained using the variable FEₐᵥₑ=(FE1+FE2+FE3)/3. From Eq. 2.33 above, the two variables should provide equivalent information in the two cases. Finally the stage is moved at constant velocity under servo control. The parameters are determined from non-linear fits to the measured data using the Marquardt-Levenberg algorithm.

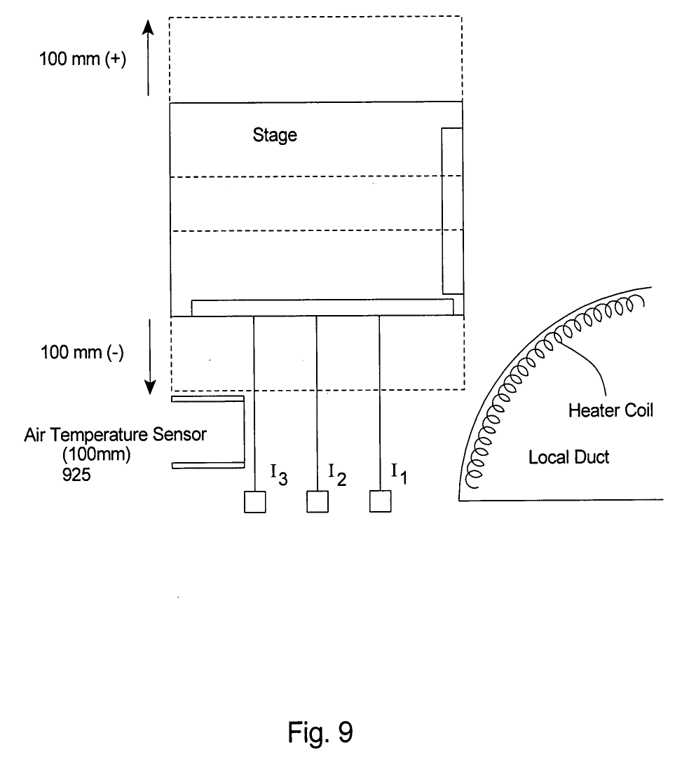

FIG. 9 shows the experimental setup used to evaluate this embodiment. A local duct, such as described in U.S. Pat. No. 5,870,197, provided a temperature controlled transverse flow of air across the interferometer beam lines. Mechanical vibrations in the stage were present, making the adaptation training difficult. Therefore heater coils were installed in the local air duct, so that the air fluctuations could be increased relative to the mechanical motions. We found that as the magnitude of the air fluctuations changed, only the threshold parameters b^{ν} and b^{μ} had to be changed. The parameters for c^{α} were fixed, because the acceleration signal was too noisy for optimization as a function of air fluctuations. A similar analysis for the stage yaw gave parameter values sufficiently close to those for the stage motion, that the latter were used for both functions.

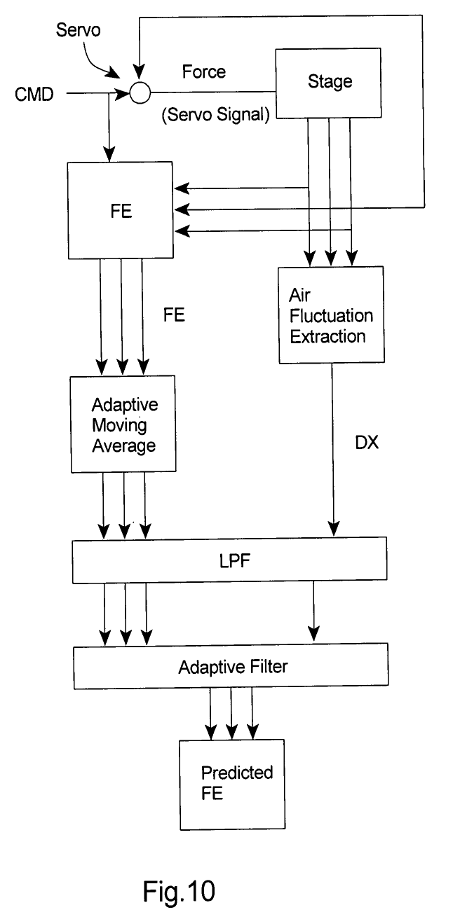

FIG. 10 schematically summarizes the prediction method of the third embodiment described above. The interferometer system locates positions of a moving stage. The stage is driven by a force applied by an actuator device (not shown in the figure) in response to a servo signal which defines a proper stage position. Each of the three interferometers generates an interferometric signal in response to the stage motion, and the interferometric signal is compared to the servo signal to produce a following error. The adaptive moving average algorithm calculates residual stage motion and yaw, and subtracts the resultant value from the following error for each of the interferometers. Concurrently, the three interferometer signals are combined to extract the mutual signal fluctuation due to the air fluctuation (DX). The three resultant following error signals and the mutual signal fluctuation are passed through a low-pass filter, the cutoff frequency of which is about 10 Hz, into the linear adaptive filter. The linear adaptive filter then uses the low-pass filtered signals to predict the air fluctuation contribution to the following error of interferometric measurement approximately 40 msec into the future. Previous predictions of the following error and the actual measured following error are used in this process. This prediction is made concurrently for each of the interferometers. It is also possible to perform the low-pass filtering immediately after the acquisition of the raw interferometric signals, rather than just before the processing by the linear adaptive filter. The predicted air fluctuation correction to FE2 is used to correct the servo signal.

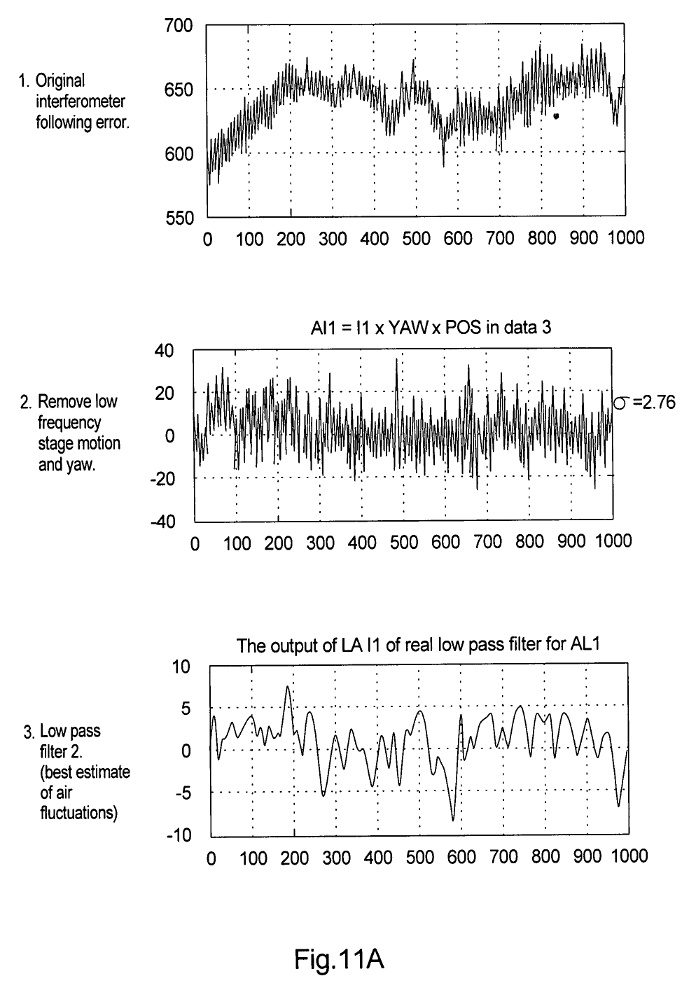

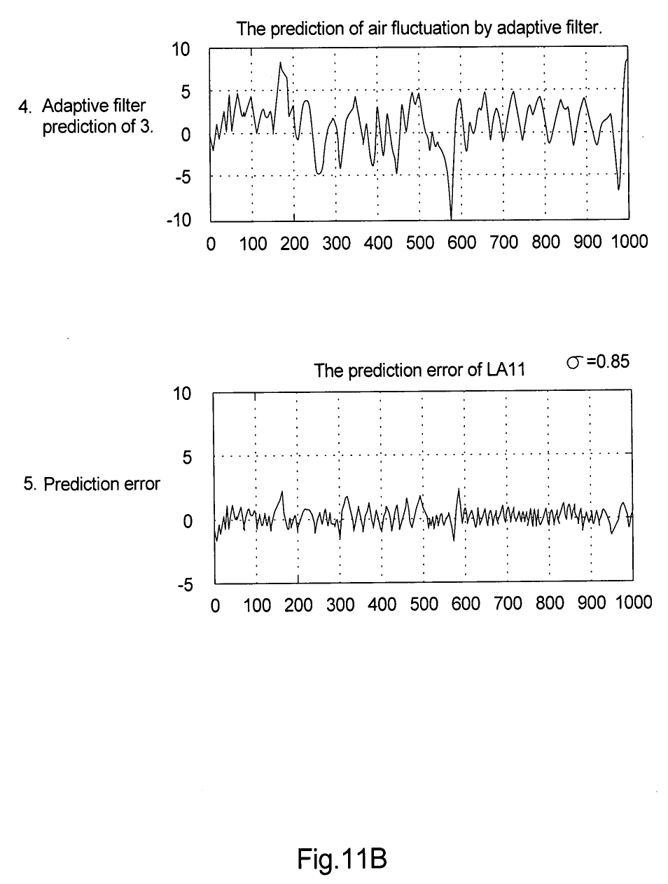

Predictions of air fluctuations were made including all of the above corrections. The fluctuation estimates were projected 46.7 msec into the future, corresponding to the delay time in the low pass filter. Additional delays in the adaptive moving average algorithm and the adaptive filter were ignored; these were significantly shorter. FIG. 11 summarizes the system performance. Low frequency stage motion and yaw are removed by the adaptive moving average algorithm (2). The resulting estimate of the air fluctuations (and residual higher frequency stage vibrations) has a standard deviation of σ=2.76 nm. After low-pass filtering (3), the adaptive filter predicts the air fluctuations 46.7 msec into the future (4). After subtracting these predictions (5), the residual standard deviation is only σ=0.85 nm, so the air fluctuations are reduced to 30% of their original value, assuming (2) has no stage vibration contributions.

The adaptive moving average algorithm is not completely successful in removing all of the low frequency stage motion, because some of the stage motion is correlated with the air fluctuations as illustrated in FIG. 8. In addition some fluctuations may simulate stage motions. For example simultaneous fluctuations δ1 and δ3, where δ1=−δ3, resemble stage yaw. An alternative algorithm can be constructed by using as much dynamic information about the stage motion as possible. An example of such an algorithm is the Kalman filter. Kalman filters are described in e.g. Andrew C. Harvey, Forecasting, Structural Time Series Models, and the Kalman Filter, Cambridge, 1991, incorporated in its entirety herein by reference for all purposes. By including both the dynamic equations of motion for the stage, and signals representing forces on the stage, from the motors and possibly sensors associated with any cables and hoses attached to the stage, a much clearer separation between air fluctuations and low frequency stage motions should be possible. Since high frequency stage motion is not a pertinent issue, the Kalman filter can be relatively simple.

In addition to identifying the air fluctuation signals through correlation estimation, the Kalman filter would not require the training of the adaptive moving average algorithm, and the time delay through it would be constant and probably shorter.

As a modification of this embodiment, prediction of the following error (FE) can be made using the following error itself, rather than using the mutual fluctuation signal (DX). The result (1) is labeled as “AFP” (adaptive filter prediction) in Table 1, together with the results (2,3) of other embodiments. The AFP value is defined as <(adaptive filter prediction error)²>^{1/2}/σ(air fluctuation), where (adaptive filter prediction error)≡(δ_{fluctuation}−δ_{prediction}); and σ(air fluctuation)=<(δ_{fluctuation})²>^{1/2}. This represents a good measure for evaluating the overall performance of the predictions system. If no corrections are applied, it follows that AFP=1.0. The success of the prediction method is reflected in AFP values less than 1.0.

Strategy 1 gives the smallest AFP. Strategy 3, using DX, is a little worse, and strategy 2 is significantly worse.

TABLE 1
Comparison among different strategies

| | AFP of FE1 | |
|---|---|---|
| | Predict 16 | Predict 8 |
| | points* ahead | points* ahead |
| Strategy | (53.3 msec) | (26.7 msec) |
| 1. Determine adaptive filter | 0.4237 | 0.0682 |
| weight coefficients with δFE1. | | |
| Predict with δFE1. | | |
| 2. Determine adaptive filter | 0.6807 | 0.6623 |
| weight coefficients with δFE1 | | |
| and DX. Predict with DX. | | |
| 3. Determine adaptive filter | 0.4739 | 0.0601 |
| weight coefficients with DX. | | |
| Predict with δFE1. | | |

*Sampling frequency 300 Hz; interleaving = 1 (every other point used); number of weight coefficients = 20; forgetting factor λ = 0.995.

These results can be understood in terms of the two contributions to the low frequency signal we are predicting: the air temperature fluctuations and the residual stage motion the cascade algorithm does not remove. The signal FE1, after the adaptive moving average algorithm correction and the low pass filter, contains both contributions. Since both the weight coefficients and the predictions are made using FE1 in Strategy 1, the adaptive filter has no trouble making predictions. However the predicted signal can be expected to include some stage motion effects. Strategy 3 determines the weight coefficients using DX. The low frequency behavior of DX should correctly reflect the air fluctuations. Therefore the weight coefficients should be more reliable than in Strategy 1, in the sense that they do not include any stage motion effects. However, since FE1 includes stage motion effects, the AFP can be expected to be somewhat worse. The difference between Strategies 1 and 3 is not very large in this case, probably because the test run has large air temperature fluctuations; it was taken with a local duct heater current of 600 mA leading to fluctuations of approximately 4-5 nm. In Strategy 2, the weights are determined using a combination of pure air fluctuation information (DX) and a mixture of air fluctuations and stage motion (FE1); this is likely to make the coefficients unstable and the predictions poor.

These conclusions are summarized in Table 2. Although Strategy 3 has somewhat larger values of AFP, it may represent the most reliable predictions.

TABLE 2
Summary of prediction strategy characteristics

| Strategy | Advantages | Disadvantages |
|---|---|---|
| 1. Determine adaptive | Smallest AFP | Prediction may include |
| filter weight coeffi- | | stage motion contribution. |
| cients with δFE1. | | |
| Predict with δFE1. | | |
| 2. Determine adaptive | If no stage motion | DX has no stage motion |
| filter weight coeffi- | contribution (i.e. | contributions. If stage |
| cients with δFE1 and | perfect cascade), | motion is present in δFE1, |
| DX. Predict with DX. | this should give | the weight coefficients |
| | best prediction. | will probably be unstable |
| | | and the predictions poor. |
| 3. Determine adaptive | With the present | Bigger AFP than |
| filter weight coeffi- | system, probably | Strategy 1. |
| cients with DX. Predict | the most reliable | |
| with δFE1. | prediction of air | |
| | fluctuations. | |

As a modification of this embodiment, air fluctuation correction predictions are made using an air temperature sensor. By including information from an air temperature sensor, located near the interferometer beams, improvement in the predictions is expected. The reasons are as follows:

1. While DX should provide information about air fluctuations associated with the transverse air flow from a local duct, it gives no information about situations where the air temperature changes simultaneously and equally at the three interferometers, as may happen for example if the air flow is parallel to the interferometer optical path instead of transverse to it (because then DX=0). The air temperature sensor can provide such information.

2. It may be possible to reduce the number of weights in the adaptive filter by including air temperature information.

3. The air temperature information is independent from that of the interferometers. Therefore it may be a useful diagnostic, if the air fluctuation correction affects the stage servo. It can also help to disentangle low frequency, correlated stage motions from the air fluctuations.

4. The temperature signal is mostly confined to low frequencies, exclusive of any noise generated in the temperature sensor electronics. The interferometer signals by contrast include high frequency contributions from stage vibration. As described in the next section, high frequency noise degrades the adaptive filter performance, and it must be filtered out. Thus including information from the temperature sensor may provide independent means of further stabilizing the adaptive filter performance.

Note however, that if the interferometer fluctuations arise from compositional changes in the gaseous fluid, such as might arise if sources of contamination are present, then the temperature sensor will not provide any useful information, save by confirming by a null result that the fluctuations are compositional in nature. However the invention described herein will still function in such a situation.

Including air temperature sensor information will change the adaptive filter cost functions, Eqs. 2.13-15 to the following:

$$\begin{matrix}{E}_{1 , n - m} ≡ {\sum }_{i = 1}^{n - m} {{λ}^{n - m - i} [ \begin{matrix}{δI}_{1 , i + m} - {αδ}_{stage} - β {δ}_{yaw} - \underline{{w}_{1}} ( n ) \cdot \\ \underline{D X} ( i ) - \underline{{w}_{1 T}} ( n ) \cdot \underline{D T} ( i )\end{matrix} ]}^{2} & ( 2.34 ) \\ {E}_{2 , n - m} ≡ {\sum }_{i = 1}^{n - m} {{λ}^{n - m - i} [ \begin{matrix}{δI}_{2 , i + m} - {αδ}_{stage} - \underline{{w}_{2}} ( n ) \cdot \\ \underline{D X} ( i ) - \underline{{w}_{2 T}} ( n ) \cdot \underline{D T} ( i )\end{matrix} ]}^{2} & ( 2.35 ) \\ {E}_{3 , n - m} ≡ {\sum }_{i = 1}^{n - m} {{λ}^{n - m - i} [ \begin{matrix}{δI}_{3 , i + m} - {αδ}_{stage} + β {δ}_{yaw} - \underline{{w}_{3}} ( n ) \cdot \\ \underline{D X} ( i ) - \underline{{w}_{3 T}} ( n ) \cdot D T ( i )\end{matrix} ]}^{2} , & ( 2.36 )\end{matrix}$$

where DT(i) is the air temperature fluctuation at time tᵢ, and W_{1T}(n), etc are the corresponding filter weights.

3. Low Pass Filter

The air fluctuations which can be predicted typically have frequencies below approximately 10 Hz. Since the stage interferometers also measure stage vibrations which can extend above several hundred Hertz, it is essential to remove the higher frequency components, in order to make predictions. This is done with a low pass filter.

The filter must have very high attenuation in the stop band, because the adaptive filter is very sensitive to noise. Also the group phase delay in the pass band should be relatively constant, to avoid phase distortion of the predictions. Finally, the delay through the low pass filter Td must not be too long, because the adaptive filter prediction time into the future must exceed the sum of Td and the other computational times. The adaptive filter predictions become poorer as the prediction time increases. Typically low pass filters become better as Td increases. Thus, there is a delicate balance between improving the low pass filter by increasing Td, but losing the filter's improvement, because the adaptive filter performance deteriorates for larger Td.

In the second and third embodiments described above, an infinite impulse response (IIR) elliptic filter was used, which accepts data at 1200 Hz sampling rate, then undersamples the data, giving an output data rate of 300 Hz. This is more than adequate, since the signal we are predicting is less than 10 Hz. The delay in this filter is approximately 14 sampling steps at 300 Hz, or Td≈47 msec.

A prototype interferometer fluctuation correction system was implemented in a digital signal processor (DSP). The total calculation time for the correction system in the DSP is less than approximately 2.8 msec per point. This is exclusive of the delay time in the low pass filter. Thus the low pass filter delay is the most serious constraint on the system's prediction performance.

4. System Architecture Considerations

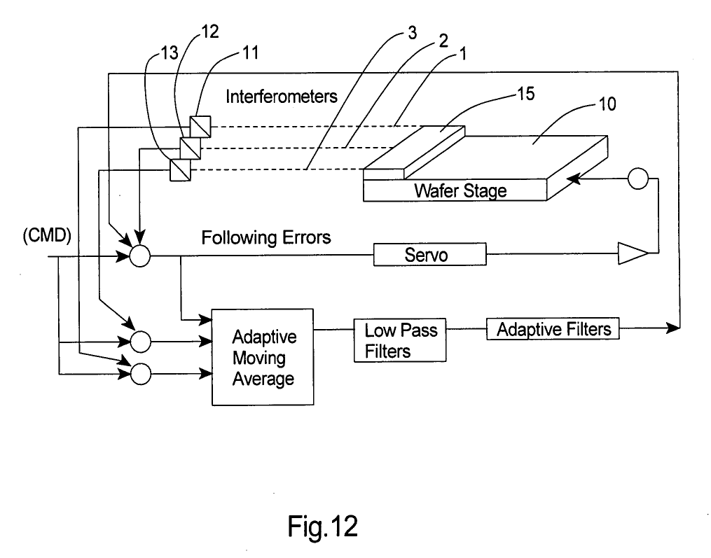

FIG. 12 shows a schematic of the overall air fluctuation correction system applied to a one dimensional motion stage. This is the system used in the second and third embodiments. The system positions a wafer stage 10 according to the servo signal (CMD) and the interferometric signals from the interferometers 11, 12, 13 having beams 1, 2, 3 reflected on a plane mirror 15 mounted on the stage 10. Not shown is a source of gaseous fluid which flows across the optical paths of the interferometers, in a direction approximately transverse to them and lying approximately in the plane defined by the optical paths. The position signal to the stage servo comes from the interferometer in the middle, 12. Yaw corrections and air fluctuation corrections are determined from the following errors from all three interferometers 11, 12, 13. Those signals are first processed by the adaptive moving average algorithm to remove low frequency stage motion and yaw, and then low-pass filtered to remove higher frequency stage motion. The resultant signals represent estimated air fluctuations and are processed by the adaptive filter to predict air temperature fluctuations. This prediction will be combined with the servo signal and the position signal from interferometer 12 to accurately position the stage 10 despite the time delay associated with detecting, processing and applying the correction signal.

Other variations of the third embodiment are possible. For example, the stage position servo could use following errors of the other interferometers, or a linear combination of them. Additionally the stage yaw could be controlled by a separate servo system with associated actuators.

Experiments with the third embodiment shows that such corrections can be applied without de-stabilizing the stage position servo. Such de-stabilization can occur if high frequency signals from the stage leak through the low pass filter and corrupt the fluctuation predictions. Experiments have shown that achieving both high stop band rejection and short delay times through the low pass filter is challenging but possible. A system design avoiding this problem is desirable.

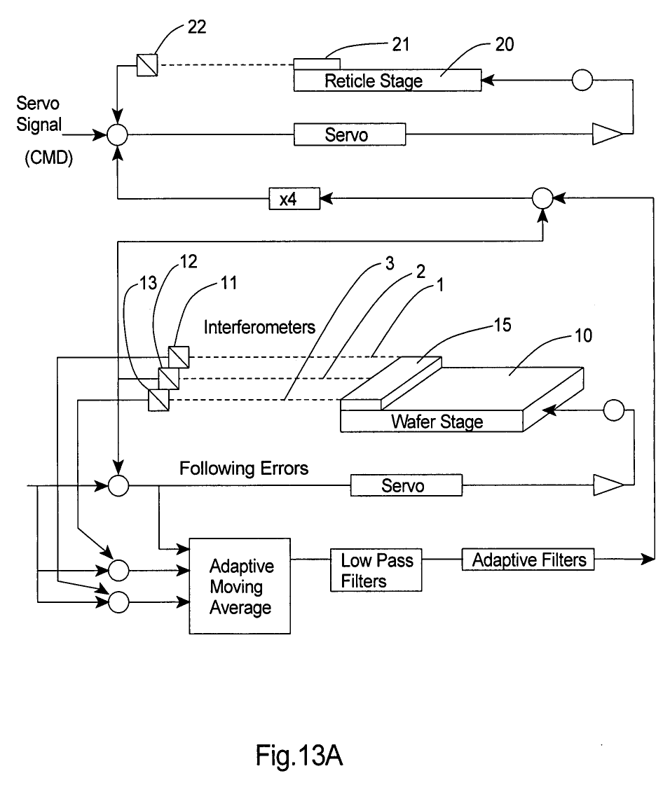

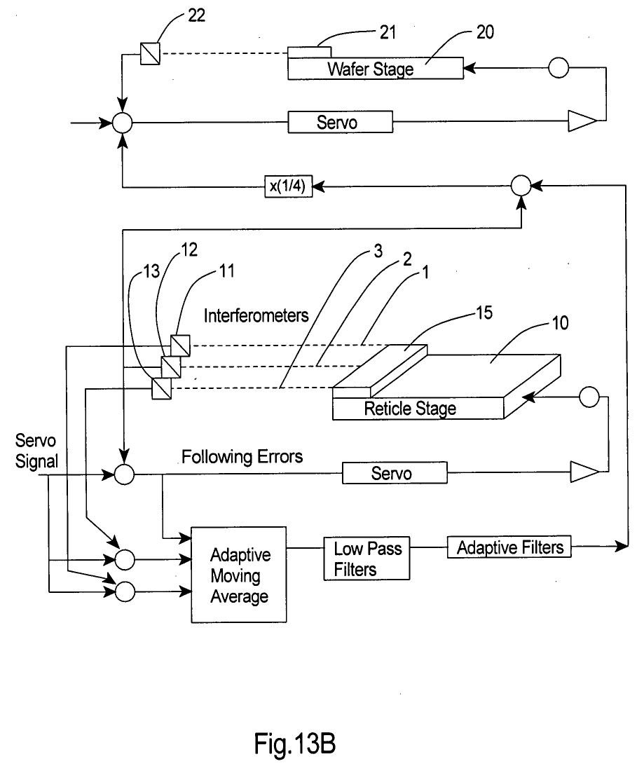

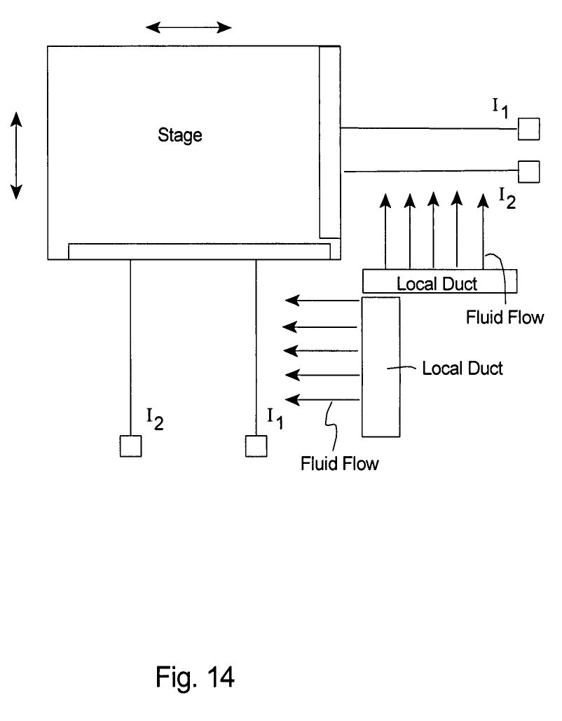

For the class of lithography systems involving two stages with coordinated motion, such a design is possible. A fourth embodiment involves this type of lithography system. A step and scan photolithography system projects light through part of a mask or reticle and focuses an image of the reticle pattern on a wafer coated with a resist sensitive to the radiation. Both the reticle and the wafer are mounted on precision stages which must move synchronously, so that the entire pattern from the reticle is sequentially imaged to the appropriate locations on the wafer. The synchronization of the two stages may be performed as shown in FIG. 13, where the location signal of the wafer stage (12) is included as a correction to the position of the reticle stage 20. The wafer stage air fluctuation correction δ_{corr.} is also included. The multiplying factor 4× is included because the image of the reticle projected on the wafer is de-magnified optically by a factor of 4. Other values of magnification are of course possible. The positioning of the reticle stage is performed based on the servo signal for the reticle stage, the position signal of the reticle stage 20 fed by the interferometer 22 having a beam reflected on a mirror 21 mounted on the reticle stage 20, and the air fluctuation correction of the interferometric signal of the wafer stage 10. In this configuration the air fluctuation correction represents an open loop correction to the reticle stage servo, consequently no instability can occur. Not shown is a source of gaseous fluid which flows across the optical paths of the wafer stage interferometers, in a direction approximately transverse to them and lying approximately in the plane defined by the optical paths.

Other variations of the fourth embodiment are possible. For example, the wafer stage position servo could use following errors of the other interferometers, or a linear combination of them. Additionally the wafer stage yaw could be controlled by a separate servo system with associated actuators. Only the wafer stage position following error, and the air fluctuation correction, are sent to the reticle stage servo. However, a wafer stage yaw following error could also be sent to the reticle stage. In addition, the reticle stage servo control might include a reticle stage yaw control as well as a reticle stage position control. All of these variations are compatible with the present invention.

The system studied so far has functioned only for one interferometer axis. Adding a second axis with another 3 interferometers should not present any problems. In this case an air conditioning system providing a flow of gaseous fluid is required, which can supply local flows approximately transverse to the optical paths of the two groups of interferometers assigned to measuring the two stage directions. The air conditioning system described in U.S. Pat. No. 5,870,197 can provide such flows.

However, with a second axis, two independent measurements of yaw are possible. This redundancy should help reduce errors in separating yaw from air fluctuations in the adaptive moving average algorithm. This assumes that the yaw is the same on the two axes. If the metrology frame flexes during stage motion, the yaws may be different, destroying the redundancy.

If redundancy is present, however, it may be possible to reduce the number of interferometers. If we have a two-dimensional system, with two interferometer axes per axis, and if the yaw is the same on each axis, there may be enough information to separate out the air fluctuation signal. The basic arguments will be discussed below as a fifth embodiment.

For the present system with three interferometers, the interferometer signals can be written as:
I1=Istage+dθ+δ₁
I2=Istage+δ₂
I3=Istage−dθ+δ₃ (4.1)
where Istage is the true stage position, θ is the stage yaw angle, the interferometer beams are separated by a distance d, and δ₁, δ₂, and δ₃ are the air temperature fluctuations. A real time variable DX which depends only on the air fluctuations is introduced as follows:
DX=I1+I3−2I2=δ₁+δ₃−2δ₂. (4.2)

This is the basis for the correction program.

For the case of four interferometers on two axes, Eqs. 4.1 become
Ix1=Ixstage+dθ/2+δx₁
Ix2=Ixstage−dθ/2+δx₂
Iy1=Iystage+dθ′/2+δy₁
Iy2=Iystage−dθ′/2+δy₂ (4.3)

The following quantities are then formed
Ix1−Ix2=dθ+δx₁−δx₂
Iy1−Iy2=dθ′+δy₁−δy₂ (4.4)

If θ=θ′, and δx₁−δx₂ is uncorrelated with δy₁−δy₂ (this is likely, since they are on different axes), then the yaw angle θₑₛₜ can be estimated from
θest=(Ix1−Ix2+Iy1−Iy2)/2d (4.5)

This is similar to the procedure in the present adaptive moving average algorithm for determining yaw, but the redundancy of the information from the two axes (and the lack of correlation in the air fluctuations) should provide a better signal.

Then real time variables depending only on air fluctuations can be defined for the two axes as
δx₁−δx₂=Ix1−Ix2−dθest
δy₁−δy₂=Iy1−Iy2−dθₑₛₜ (4.6)

Then a program similar to the present one can be established.

There are several assumptions in this. The first is that θ=θ′. This needs to be tested. It may be that the yaw associated with the mechanical flexing of the metrology frame has sufficiently different spectral or temporal properties from the stage yaw that the two contributions can be distinguished, possibly with the help of a Kalman filter. Another assumption is that Eq. 4.5 provides a sufficiently accurate measure of the yaw.

As mentioned above, the two axes provide a redundancy not available in one axis, which may improve the performance of an adaptive moving average type algorithm. For example, stage yaw should give a very strong correlation between the quantities (Ix1−Ix2) and (Iy1−Iy2). Similarly, low frequency stage vibrations will in general have components in both the x and y directions, leading to correlation in the quantities (Ix1+Ix2−2CMDx)/2 and (Iy1+Iy2−2CMDy)/2, where CMDx and CMDy are the command signals for the two axes. These are basically the following errors for the two axes. If the adaptive moving average algorithm can be modified to use these correlations, it may be able to separate air fluctuations from stage motions with greater efficiency.

The systems described above should work if the stage is pitching as well as yawing. A fourth interferometer beam is needed, if significant pitching is also present. Since pitching only affects one axis, no redundant information is created by simultaneously monitoring the second axis.

The above is a detailed description of particular embodiments of the invention. It is recognized that departures from the disclosed embodiments may be made within the scope of the invention and that obvious modifications will occur to a person skilled in the art. The full scope of the invention is set out in the claims that follow and their equivalents. Accordingly, the claims and specification should not construed to narrow the full scope of protection to which the invention is entitled.

What is claimed is:

1. A method of predicting a signal fluctuation due to a gaseous fluid in an optical path of an interferometric measuring apparatus, the method comprising the steps of:
obtaining an interferometric signal generated by the interferometric measuring apparatus; and
predicting a future fluctuation of the signal using a neural network.

2. The method of claim 1 further comprising the step of filtering out components of the interferometric signal of a frequency higher than a cutoff frequency.

3. The method of claim 2 wherein the prediction is made 80 milliseconds into the future or less.

4. The method of claim 2 further comprising the steps of acquiring the signal at a predetermined interval and using a weight vector (W) as part of the neural network for calculating a predicted signal wherein the weight vector is determined recursively at each signal acquisition such that differences between the predicated signals prior to a current signal acquisition and corresponding measured signals satisfy a least square requirement (E).

5. The method of claim 4 wherein a predetermined number of measured signals each separated by predetermined time intervals determines the weight vector (W).

6. The method of claim 1 wherein the neural network is a linear adaptive filter.

7. The method of claim 1 wherein the interferometric measuring apparatus determines the position of a first stage and movement of the first stage is controlled by a first servo.

8. The method of claim 7 wherein the predicted signal fluctuation is used to correct the position of the first stage.

9. The method of claim 8 wherein a second stage is controlled by a second servo, and a position of the second stage is synchronized with that of the first stage, and the predicted fluctuation determined from the interferometric measuring apparatus of the first stage is used to correct the position of the second stage.

10. A method of predicting a signal fluctuation due to a flow of gaseous fluid in an optical path between a stage under a servo control and an interferometric measuring apparatus for determining a correction to a position of the stage in a direction of a stage movement, said flow being approximately across the optical path axis, the method comprising the steps of:
acquiring three interferometric signals of three parallel optical beams, lying within the flow of gaseous fluid, reflected from predetermined portions of the stage, said optical path being substantially parallel to the direction of the stage movement;
determining a following error (FE) by subtracting a position defined by the acquired interferometric signal from a position defined by a servo signal (CMD) as a predetermined position;
determining a residual stage motion and a residual stage yaw using adaptive moving averages of acceleration, velocity and position of the stage;
obtaining a signal fluctuation due to a flow of gaseous fluid in the following error by subtracting the determined residual stage motion and residual stage yaw from the following error; and
predicting a future following error from the obtained signal fluctuation using an adaptive filter.

11. The method of claim 10 wherein the adaptive moving averages of acceleration, velocity and position of the stage are obtained by a weight average (F) of each of three physical quantities, said weighted average being recursively calculated at each signal acquisition.

12. The method of claim 11 wherein weighting parameters of the adaptive moving average are trained to fit measured stage interferometric data.

13. The method of claim 12, wherein a predetermined number of measured signal each separated by predetermined time intervals determine the weight vector.

14. The method of claim 12, further comprising filtering out components of the interferometric signal of a frequency higher than a cutoff frequency.

15. The method of claim 14, wherein only one adaptive filter is provided for a predetermined optical path for predicting the future following error (FE) of the interferometric signal of said optical path, and the future following error of the other optical paths are estimated from the predicted future following error of the predetermined optical path.

16. The method of claim 14, wherein one adaptive filter is provided for each of the three optical paths for predicting the future following error of the corresponding optical path.

17. The method of claim 14, wherein the filtering is performed on the interferometric signal directly out of the optical path

18. The method of 10 wherein the step of determining a residual stage motion and a residual stage yaw is performed using a Kalman filter, which includes dynamic equations of motion for the stage and signals representing forces on the stage, as well as the interferometric signals.

19. A method of predicting a signal fluctuation due to flows of gaseous fluid in an optical path between a stage and an interferometric measuring apparatus for determining a position of the stage moving in two directions, said directions being perpendicular to each other, and said flows being locally approximately across the two directions, the method comprising:
acquiring two interferometric signals of two parallel optical beams, lying within a flow of gaseous fluid, reflected from predetermined portions of the stage for each of the two directions of the stage movement, said optical paths being parallel to the corresponding directions of the stage movement;
extracting a mutual signal fluctuation due to flows of gaseous fluid from the four interferometric signals for each of the two directions, and
predicting a future fluctuation of the interferometric signal using a linear adaptive filter (W) acting on the extracted mutual signal fluctuation.

20. The method of claim 19, wherein the extraction of the mutual signal fluctuation assumes that a stage yaw is the same on the two directions.

21. A method of predicting a signal fluctuation due to fluctuations in temperature of a flow of gaseous fluid in an optical path of an interferometric measuring apparatus, said flow being approximately across the optical path axis, using measurements from a gaseous fluid temperature sensor, located in proximity to the interferometric measuring apparatus, comprising:
obtaining a gaseous fluid temperature signal generated by the gaseous fluid temperature sensor; and
predicting a future fluctuation of the signal of the interferometric measuring apparatus using a neural network.

22. The method of claim 21, wherein the length of the temperature sensitive portion of the temperature sensor is of similar length to the beam path of the interferometric measuring apparatus.

23. The method of claim 21 wherein the fluid temperature sensor is located substantially parallel to and upstream of the interferometric measuring apparatus relative to the direction of the transverse flow of the gaseous fluid.

24. The method of claim 21 wherein the interferometric measuring apparatus determines the position of a first stage and movement of the first stage is controlled by a first servo.

25. The method of claim 24 wherein a second stage is controlled by a second servo, and a position of the second stage is synchronized with that of the first stage, and the predicted fluctuation determined from the interferometric measuring apparatus of the first stage is used to correct the position of the second stage.

26. A method of predicting a signal fluctuation due to a flow of gaseous fluid in an optical path between a stage and an interferometric measuring apparatus, said flow being approximately across the optical path axis, for determining a correction to a position of the stage in a direction of a stage movement, the method comprising:
acquiring three interferometric signals of three parallel optical beams, lying within the flow of gaseous fluid, reflected from predetermined portions of the stage, said optical paths being parallel to the direction of the stage movement;
extracting a mutual signal fluctuation (DX) caused by an air fluctuation from the three interferometric signals; and
predicting a future fluctuation of the interferometric signal using a linear adaptive filter acting on the extracted mutual signal fluctuation.

27. The method of claim 26 further comprising the steps of positioning the three optical paths at an equivalent interval and extracting the mutual signal fluctuation (DX) by summing up two interferometric signals of the optical paths positioned at both sides and subtracting from the sum an amount twice as large as the interferometric signal of the optical path positioned in a center.

28. The method of claim 26 further comprising the step of filtering out components of the interferometric signal of a frequency higher than a cutoff frequency.

29. The method of claim 26 further comprising the steps of:
acquiring the interferometric signals of the three optical paths at a predetermined interval; and
using a weight vector (W) as part of the linear adaptive filter for calculating the future fluctuation based on the extracted mutual signal fluctuation (DX) caused by an air fluctuation;
wherein the weight vector is determined recursively at each signal acquisition such that differences between the predicted signals prior to a current signal acquisition and corresponding measured signals satisfy a least square requirement (E).

30. The method of claim 29 wherein a predetermined number of measured signals each separated by predetermined time intervals determine the weight vector (W).

31. The method of claim 29 wherein only one linear adaptive filter is provided for a predetermined optical path for predicting the future fluctuation of the interferometric signal of said optical path, and the future fluctuations of the other optical paths are estimated from the future fluctuation of the predetermined optical path.

33. The method of claim 29 wherein one linear adaptive filter is provided for each of the three optical paths for predicting the future fluctuation of the corresponding optical path.

34. The method of predicting a signal fluctuation of claim 26, further comprising:
acquiring the interferometric signals of the three optical paths at a predetermined interval; and
using a weight vector (W) as part of the adaptive filter for calculating the future fluctuation based on the extracted mutual signal fluctuation (DX) caused by an air fluctuation;
wherein the weight vector and parameters for the stage motion and yaw are determined recursively at each signal acquisition such that differences between the predicted following errors prior to a current signal acquisition and corresponding measured signals satisfy a least square requirement (E).

35. A method of predicting a signal fluctuation due to flows of gaseous fluid in an optical path between a stage under a servo control and an interferometric measuring apparatus for determining a position of the stage moving in two directions, said directions being perpendicular to each other, and said flows being locally approximately across the two stage directions, the method comprising:
acquiring two interferometric signals of two parallel optical beams, lying within a flow of gaseous fluid, reflected from predetermined portions of the stage for each of the two directions of the stage movement, said optical paths being parallel to the corresponding direction of the stage movement;
determining a following error (FE) by subtracting a position defined by the acquired interferometric signal from a position defined by a servo signal (CMD) as a predetermined position;
determining a residual stage motion and a residual stage yaw using adaptive moving averages of acceleration, velocity and position of the stage for each of the two directions;
obtaining a signal fluctuation due to flows of gaseous fluid in the following error by subtracting the determined residual stage motion and yaw from the following error for each of the two directions; and
predicting a correction to a future following error from the obtained signal fluctuation using a linear adaptive filter acting on the extracted mutual signal fluctuation for each of the two directions.

36. The method of claim 35 wherein the extraction of the signal fluctuation assumes that a stage yaw is the same on the two directions.

37. A stage position control system comprising:
a plurality of interferometers for measuring a position of a stage in directions of stage movement; the interferometric signals of said interferometers being combined to provide a mutual signal fluctuation (DX);
a servo unit to provide a servo signal (CMD) to position the stage according to a predetermined sequence;
a device comprising an adaptive filter acting on the mutual signal fluctuation (DX) for predicting a signal fluctuation due to the flow of a gaseous fluid in an optical path of the interferometers, the flow being approximately transverse to the optical path; and
a control unit which removes the predicted signal fluctuations of the interferometric signals from current interferometric signals and uses the current interferometric signals without the predicted signal fluctuations in addition to the servo signal to position the stage accurately.

38. The stage position control system of claim 37, wherein three interferometers are used for measuring the position of the stage.

39. The stage position control system of claim 37, wherein the device further comprises an adaptive moving average algorithm for a residual stage motion and yaw, and a low pass filter for removing high frequency components of the interferometric signal.

40. The stage position control system of claim 37, further comprising an array of temperature sensors along the optical path of the interferometer which feeds a set of measured temperature values to the adaptive filter.

41. A stage position control system including a first stage and a second stage, motions of said stages being coordinated, the system comprising:
a plurality of interferometers for measuring a position of the second stage in directions of stage movement; the interferometric signals of said interferometers being processed to provide estimates of signal fluctuations due to flows of a gaseous fluid;
a servo unit to provide a servo signal (CMD) to position the second stage according to a predetermined sequence;
a device comprising an adaptive filter acting on the estimated signal fluctuations for predicting signal fluctuations due to flows of a gaseous fluid in the optical paths of the interferometers; and
a control unit which removes the predicted signal fluctuations of the interferometric signals from current interferometric signals and uses the corrected current interferometric signals without the predetermined signal fluctuations in addition to the servo signal to position the first stage in a synchronization mode.

42. The stage position control system of claim 41, wherein three interferometers are used for measuring the position of the second stage in one direction.

43. The stage position control system of claim 41 wherein the first stage is a reticle stage that retains a reticle and the second stage is a wafer stage that retains a wafer.

44. The stage position control system of claim 41 wherein the second stage is a reticle stage that retains a reticle and the first stage is a wafer stage that retains a wafer.

45. The stage position control system of claim 41 wherein the estimates of signal fluctuations are obtained by determining a following error (FE) by subtracting a position defined by the acquired interferometric signals from a position defined by a servo signal (CMD) as a predetermined position;
determining a residual stage motion and a residual stage yaw using adaptive moving averages of acceleration, velocity and position of the stage;
obtaining signal fluctuations, due to a flow of gaseous fluid, in the following error by subtracting the determined residual stage motion and yaw from the following error and the interferometric signals used in defining the following error initially.

46. The stage position control system of claim 41 wherein a mutual signal fluctuation (DX) is used with an adaptive filter signal fluctuations.

47. The stage position control system of claim 41 wherein the estimates of signal fluctuations are obtained by determining a following error (FE) by subtracting a position defined by the acquired interferometric signals from a position defined by a servo signal (CMD) as a predetermined position;
determining a residual stage motion and a residual stage yaw using a Kalman filter;
obtaining signal fluctuations, due to a flow of gaseous fluid, in the following error by subtracting the determined residual stage motion and yaw from the following error and the interferometric signals used in defining the following error initially.

48. A method of predicting a signal fluctuation due to a gaseous fluid in an optical path of an interferometric measuring apparatus, comprising:
moving a stage;
obtaining an interferometric signal generated by the interferometric measuring apparatus;
determining a following error of the stage;
determining a mutual signal fluctuation (DX) caused by gaseous fluid fluctuation;
determining a weight vector of the adaptive filter using the mutual signal fluctuation; and predicting a future fluctuation of the signal using an adaptive filter.

49. The method of claim 48 wherein the step of determining the weight vector includes using the following error in addition to the mutual signal fluctuation.
